(19) United States
(12) Patent Application Publication
(10) Pub. No.: US 2025/0386353 A1
(43) Pub. Date: Dec. 18, 2025

(54) PHYSICAL DOWNLINK CONTROL CHANNEL DESIGN FOR FLEXIBLE SPECTRUM INTEGRATION

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Jing JIANG, San Diego, CA (US); Gabi SARKIS, San Diego, CA (US)

(21) Appl. No.: 18/744,468

(22) Filed: Jun. 14, 2024

(51) Int. Cl. H04W 72/23; H04L 5/00

(52) U.S. Cl. CPC H04W 72/23; H04L 5/0098

(57) ABSTRACT

Methods, systems, and devices for wireless communications are described. A UE may receive configuration information that indicates a plurality of monitoring occasions in multiple sub-bands for monitoring of a set of physical downlink control channel (PDCCH). The set of PDCCH candidates may be distributed across the multiple sub-bands. The UE may perform a first set of blind decodes during a first monitoring occasion. The first monitoring occasion may be associated with a first search space set of a first PDCCH core resource set (CORESET) in a first sub-band. The UE may perform a second set of blind decodes during a second monitoring occasion. The second monitoring occasion may be associated with a second search space set of a second PDCCH CORESET in a second sub-band. The configuration information may associate the first search space set with the second search space set.

### FIELD OF TECHNOLOGY

The following relates to wireless communications, including physical downlink control channel (PDCCH) design for flexible spectrum integration (FSI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that indicates a set of multiple monitoring occasions in multiple sub-bands for monitoring of a set of multiple physical downlink control channel (PDCCH) candidates for reception of a control channel or repetitions of the control channel, where the set of multiple PDCCH candidates are distributed across the multiple sub-bands, performing, in accordance with the configuration information, a first set of blind decodes during a first monitoring occasion of the set of multiple monitoring occasions, where the first monitoring occasion is associated with a first search space set of a first PDCCH core resource set (CORESET) in a first sub-band of the multiple sub-bands, performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set, and decoding the control channel or the repetitions of the control channel based on the first set of blind decodes and the second set of blind decodes.

A UE for wireless communications is described. The UE may include one or more memories storing processor executable code, and one or more processors coupled with the one or more memories. The one or more processors may individually or collectively be operable to execute the code to cause the UE to receive configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands, perform, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands, perform, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set, and decode the control channel or the repetitions of the control channel based on the first set of blind decodes and the second set of blind decodes.

Another UE for wireless communications is described. The UE may include means for receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands, means for performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands, means for performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set, and means for decoding the control channel or the repetitions of the control channel based on the first set of blind decodes and the second set of blind decodes.

A non-transitory computer-readable medium storing code for wireless communications is described. The code may include instructions executable by one or more processors to receive configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands, perform, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands, perform, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set, and decode the control channel or the repetitions of the control channel based on the first set of blind decodes and the second set of blind decodes.

In some examples of the method, UEs, and non-transitory computer-readable medium described herein, the first PDCCH CORESET and the second PDCCH CORESET may be different and the first search space set and the second search space set may be different.

In some examples of the method, UEs, and non-transitory computer-readable medium described herein, the first search space set and the second search space set may be associated via a mapping between search space sets of different sub-bands and the mapping may be on a per group of PDCCH candidates basis.

In some examples of the method, UEs, and non-transitory computer-readable medium described herein, a first coreset configuration associated with the first PDCCH CORESET may be independent of a second PDCCH CORESET configuration associated with the second PDCCH CORESET.

In some examples of the method, UEs, and non-transitory computer-readable medium described herein, one or more parameters of a first coreset configuration associated with the first PDCCH CORESET may be the same as a corresponding one or more parameters of a second PDCCH CORESET configuration associated with the second PDCCH CORESET and the one or more parameters include at least one of an aggregation level (AL), a payload, a quantity of coded bits, or a search space set type.

In some examples of the method, UEs, and non-transitory computer-readable medium described herein, the set of multiple PDCCH candidates that may be distributed across the multiple sub-bands may be part of a virtual carrier and the method, apparatuses, and non-transitory computer-readable medium may include further operations, features, means, or instructions for refraining from monitoring a third search space set based on a dropping rule, where the dropping rule indicates that search space sets may be dropped from monitoring based on an ordering of sub-band indices and search space set indices.

In some examples of the method, UEs, and non-transitory computer-readable medium described herein, the set of multiple PDCCH candidates that may be distributed across the multiple sub-bands may be part of a virtual carrier and the method, apparatuses, and non-transitory computer-readable medium may include further operations, features, means, or instructions for refraining from monitoring a third search space set based on a dropping rule, where the dropping rule indicates that search space sets may be dropped from monitoring based on an ordering of candidate indices.

Some examples of the method, UEs, and non-transitory computer-readable medium described herein may further include operations, features, means, or instructions for transmitting a UE report indicating a quantity of blind decodes based on a quantity of associated search space sets indicated by the configuration information.

In some examples of the method, UEs, and non-transitory computer-readable medium described herein, an effective AL corresponding to the set of multiple PDCCH candidates may be based on a quantity of sub-bands associated with the set of multiple PDCCH candidates.

In some examples of the method, UEs, and non-transitory computer-readable medium described herein, the effective AL may be based on a uniform distribution of control channel elements (CCEs) of a PDCCH candidate having a first AL within a search space set associated with the set of multiple PDCCH candidates across the quantity of sub-bands.

In some examples of the method, UEs, and non-transitory computer-readable medium described herein, the effective AL may be based on a non-uniform distribution of CCEs of a PDCCH candidate having a first AL within a search space set associated with the set of multiple PDCCH candidates across the quantity of sub-bands.

In some examples of the method, UEs, and non-transitory computer-readable medium described herein, the first PDCCH CORESET and the second PDCCH CORESET may be different and the first search space set and the second search space set may be portions of a same search space set.

In some examples of the method, UEs, and non-transitory computer-readable medium described herein, the first search space set includes a quantity of control channel resources on the first PDCCH CORESET and the second search space set includes the quantity of control channel resources on the second PDCCH CORESET and a first PDCCH candidate associated with the first search space set and a second PDCCH candidate associated with the second search space set may have a same AL, the first PDCCH candidate and the second PDCCH candidate being of the set of multiple PDCCH candidates.

In some examples of the method, UEs, and non-transitory computer-readable medium described herein, the set of multiple PDCCH candidates that may be distributed across the multiple sub-bands may be part of a virtual carrier and the method, apparatuses, and non-transitory computer-readable medium may include further operations, features, means, or instructions for refraining from monitoring the first search space set based on a dropping rule, where the dropping rule indicates that search space sets may be dropped from monitoring based on an ordering of sub-band indices and search space set indices.

In some examples of the method, UEs, and non-transitory computer-readable medium described herein, the set of multiple PDCCH candidates that may be distributed across the multiple sub-bands may be part of a virtual carrier and the method, apparatuses, and non-transitory computer-readable medium may include further operations, features, means, or instructions for refraining from monitoring the first search space set based on a dropping rule, where the dropping rule indicates that search space sets may be dropped from monitoring based on an ordering of candidate indices.

In some examples of the method, UEs, and non-transitory computer-readable medium described herein, an effective AL corresponding to the set of multiple PDCCH candidates may be based on a quantity of control channel resources associated with the set of multiple PDCCH candidates and a same AL.

In some examples of the method, UEs, and non-transitory computer-readable medium described herein, the effective AL may be based on a uniform distribution of CCEs of a PDCCH candidate having a first AL within the same search space set associated with the set of multiple PDCCH candidates across the quantity of sub-bands.

In some examples of the method, UEs, and non-transitory computer-readable medium described herein, the effective AL may be based on a non-uniform distribution of CCEs of a PDCCH candidate having a first AL within the same search space set associated with the set of multiple PDCCH candidates across the quantity of sub-bands.

Some examples of the method, UEs, and non-transitory computer-readable medium described herein may further include operations, features, means, or instructions for transmitting a UE report indicating a quantity of blind decodes based on a quantity of associated search space sets indicated by the configuration information.

In some examples of the method, UEs, and non-transitory computer-readable medium described herein, the first PDCCH CORESET and the second PDCCH CORESET may be portions of a same PDCCH CORESET and the same PDCCH CORESET includes a first resource block (RB) set in the first sub-band and a second RB set in the second sub-band.

In some examples of the method, UEs, and non-transitory computer-readable medium described herein, the first RB set may be associated with a first quasi co-located (QCL) source and a first transmission configuration indicator (TCI) state, the second RB set may be associated with a second QCL source and a second TCI state, the first QCL source may be different than the second QCL source, and the first TCI state may be different than the second TCI state.

In some examples of the method, UEs, and non-transitory computer-readable medium described herein, the first search space set and the second search space set may be portions of a same search space set and the first search space set may be associated with the first RB set and the second search space set may be associated with the second RB set.

In some examples of the method, UEs, and non-transitory computer-readable medium described herein, the same search space set may be associated with a hashing function for the first RB set and the second RB set and the first RB set and the second RB set include a same quantity of control channel resources.

In some examples of the method, UEs, and non-transitory computer-readable medium described herein, the same search space set may be associated with a first hashing function for the first RB set and a second hashing function for the second RB set.

In some examples of the method, UEs, and non-transitory computer-readable medium described herein, the first search space set and the second search space set may be different and the first search space set may be associated with the first RB set and the second search space set may be associated with the second RB set.

In some examples of the method, UEs, and non-transitory computer-readable medium described herein, the first search space set may be associated with a first hashing function for the first RB set and the second search space set may be associated with a second hashing function for the second RB set.

In some examples of the method, UEs, and non-transitory computer-readable medium described herein, CCEs of a PDCCH candidate having a first AL associated within a search space set of the same PDCCH CORESET may be uniformly distributed across a quantity of sub-bands associated with the same PDCCH CORESET.

In some examples of the method, UEs, and non-transitory computer-readable medium described herein, each resource element group (REG) bundle of the same PDCCH CORESET may be included within a respective sub-band.

In some examples of the method, UEs, and non-transitory computer-readable medium described herein, CCEs of a PDCCH candidate having a respective AL within a search space set of the same PDCCH CORESET may be non-uniformly distributed across a quantity of sub-bands associated with the same PDCCH CORESET.

In some examples of the method, UEs, and non-transitory computer-readable medium described herein, a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

In some examples of the method, UEs, and non-transitory computer-readable medium described herein, an effective AL corresponding to the set of multiple PDCCH candidates may be based on a quantity of RBs associated with the set of multiple PDCCH candidates.

A method for wireless communications by a network entity is described. The method may include transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands, transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands, and transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

A network entity for wireless communications is described. The network entity may include one or more memories storing processor executable code, and one or more processors coupled with the one or more memories. The one or more processors may individually or collectively be operable to execute the code to cause the network entity to transmit configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands, transmit, in accordance with the configuration information, a first control message during a first monitoring occasion of the set of multiple monitoring occasions, where the first monitoring occasion is associated with a first search space of a first PDCCH CORESET in a first sub-band of the multiple sub-bands, and transmit, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

Another network entity for wireless communications is described. The network entity may include means for transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands, means for transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands, and means for transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

A non-transitory computer-readable medium storing code for wireless communications is described. The code may include instructions executable by one or more processors to transmit configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands, transmit, in accordance with the configuration information, a first control message during a first monitoring occasion of the set of multiple monitoring occasions, where the first monitoring occasion is associated with a first search space of a first PDCCH CORESET in a first sub-band of the multiple sub-bands, and transmit, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

In some examples of the method, network entities, and non-transitory computer-readable medium described herein, the first PDCCH CORESET and the second PDCCH CORESET may be different and the first search space set and the second search space set may be different.

In some examples of the method, network entities, and non-transitory computer-readable medium described herein, the first search space set and the second search space set may be associated via a mapping between search space sets of different sub-bands and the mapping may be on a per group of PDCCH candidates basis.

In some examples of the method, network entities, and non-transitory computer-readable medium described herein, a first coreset configuration associated with the first PDCCH CORESET may be independent of a second PDCCH CORESET configuration associated with the second PDCCH CORESET.

In some examples of the method, network entities, and non-transitory computer-readable medium described herein, one or more parameters of a first coreset configuration associated with the first PDCCH CORESET may be the same as a corresponding one or more parameters of a second PDCCH CORESET configuration associated with the second PDCCH CORESET and the one or more parameters include at least one of an AL, a payload, a quantity of coded bits, or a search space set type.

Some examples of the method, network entities, and non-transitory computer-readable medium described herein may further include operations, features, means, or instructions for receiving a UE report indicating a quantity of blind decodes based on a quantity of associated search space sets indicated by the configuration information.

In some examples of the method, network entities, and non-transitory computer-readable medium described herein, an effective AL corresponding to the set of multiple PDCCH candidates may be based on a quantity of sub-bands associated with the set of multiple PDCCH candidates.

In some examples of the method, network entities, and non-transitory computer-readable medium described herein, the effective AL may be based on a uniform distribution of CCEs of a PDCCH candidate having a first AL within a search space set associated with the set of multiple PDCCH candidates across the quantity of sub-bands.

In some examples of the method, network entities, and non-transitory computer-readable medium described herein, the effective AL may be based on a non-uniform distribution of CCEs of a PDCCH candidate having a first AL within a search space set associated with the set of multiple PDCCH candidates across the quantity of sub-bands.

In some examples of the method, network entities, and non-transitory computer-readable medium described herein, the first PDCCH CORESET and the second PDCCH CORESET may be different and the first search space set and the second search space set may be portions of a same search space set.

In some examples of the method, network entities, and non-transitory computer-readable medium described herein, the first search space set includes a quantity of control channel resources on the first PDCCH CORESET and the second search space set includes the quantity of control channel resources on the second PDCCH CORESET and a first PDCCH candidate associated with the first search space set and a second PDCCH candidate associated with the second search space set may have a same AL, the first PDCCH candidate and the second PDCCH candidate being of the set of multiple PDCCH candidates.

In some examples of the method, network entities, and non-transitory computer-readable medium described herein, an effective AL corresponding to the set of multiple PDCCH candidates may be based on a quantity of control channel resources associated with the set of multiple PDCCH candidates and a same AL.

In some examples of the method, network entities, and non-transitory computer-readable medium described herein, the effective AL may be based on a uniform distribution of CCEs of a PDCCH candidate having a first AL within the same search space set associated with the set of multiple PDCCH candidates across the quantity of sub-bands.

In some examples of the method, network entities, and non-transitory computer-readable medium described herein, the effective AL may be based on a non-uniform distribution of CCEs of a PDCCH candidate having a first AL within the same search space set associated with the set of multiple PDCCH candidates across the quantity of sub-bands.

Some examples of the method, network entities, and non-transitory computer-readable medium described herein may further include operations, features, means, or instructions for receiving a UE report indicating a quantity of blind decodes based on a quantity of associated search space sets indicated by the configuration information.

In some examples of the method, network entities, and non-transitory computer-readable medium described herein, the first PDCCH CORESET and the second PDCCH CORESET may be portions of a same PDCCH CORESET and the same PDCCH CORESET includes a first RB set in the first sub-band and a second RB set in the second sub-band.

In some examples of the method, network entities, and non-transitory computer-readable medium described herein, the first RB set may be associated with a first QCL source and a first TCI state, the second RB set may be associated with a second QCL source and a second TCI state, the first QCL source may be different than the second QCL source, and the first TCI state may be different than the second TCI state.

In some examples of the method, network entities, and non-transitory computer-readable medium described herein, the first search space set and the second search space set may be portions of a same search space set and the first search space set may be associated with the first RB set and the second search space set may be associated with the second RB set.

In some examples of the method, network entities, and non-transitory computer-readable medium described herein, the same search space set may be associated with a hashing function for the first RB set and the second RB set and the first RB set and the second RB set include a same quantity of control channel resources.

In some examples of the method, network entities, and non-transitory computer-readable medium described herein, the same search space set may be associated with a first hashing function for the first RB set and a second hashing function for the second RB set.

In some examples of the method, network entities, and non-transitory computer-readable medium described herein, the first search space set and the second search space set may be different and the first search space set may be associated with the first RB set and the second search space set may be associated with the second RB set.

In some examples of the method, network entities, and non-transitory computer-readable medium described herein, the first search space set may be associated with a first hashing function for the first RB set and the second search space set may be associated with a second hashing function for the second RB set.

In some examples of the method, network entities, and non-transitory computer-readable medium described herein, CCEs of a PDCCH candidate having a first AL associated within a search space set of the same PDCCH CORESET may be uniformly distributed across a quantity of sub-bands associated with the same PDCCH CORESET.

In some examples of the method, network entities, and non-transitory computer-readable medium described herein, each REG bundle of the same PDCCH CORESET may be included within a respective sub-band.

In some examples of the method, network entities, and non-transitory computer-readable medium described herein, CCEs of a PDCCH candidate having a respective AL within a search space set of the same PDCCH CORESET may be non-uniformly distributed across a quantity of sub-bands associated with the same PDCCH CORESET.

In some examples of the method, network entities, and non-transitory computer-readable medium described herein, a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

In some examples of the method, network entities, and non-transitory computer-readable medium described herein, an effective AL corresponding to the set of multiple PDCCH candidates may be based on a quantity of RBs associated with the set of multiple PDCCH candidates.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports physical downlink control channel (PDCCH) design for flexible spectrum integration (FSI) in accordance with one or more aspects of the present disclosure.

FIG. 2 shows an example of a wireless communications system that supports PDCCH design for FSI in accordance with one or more aspects of the present disclosure.

FIG. 3A shows an example of a TB scheduling configuration that supports PDCCH design for FSI in accordance with one or more aspects of the present disclosure.

FIG. 3B shows an example of a TB scheduling configuration that supports PDCCH design for FSI in accordance with one or more aspects of the present disclosure.

FIG. 4 shows an example of a control channel resource configuration that supports PDCCH design for FSI in accordance with one or more aspects of the present disclosure.

FIG. 5 shows an example of a CORESET configuration that supports PDCCH design for FSI in accordance with one or more aspects of the present disclosure.

FIG. 6 shows an example of a virtual cell that supports PDCCH design for FSI in accordance with one or more aspects of the present disclosure.

FIG. 7A shows an example of a virtual cell that supports PDCCH design for FSI in accordance with one or more aspects of the present disclosure.

FIG. 7B shows an example of a virtual cell that supports PDCCH design for FSI in accordance with one or more aspects of the present disclosure.

FIG. 8 shows an example of a virtual cell that supports PDCCH design for FSI in accordance with one or more aspects of the present disclosure.

FIG. 9 shows an example of a communications timeline that supports PDCCH design for FSI in accordance with one or more aspects of the present disclosure.

FIG. 10 shows an example of a process flow that supports PDCCH design for FSI in accordance with one or more aspects of the present disclosure.

FIGS. 11 and 12 show block diagrams of devices that support PDCCH design for FSI in accordance with one or more aspects of the present disclosure.

FIG. 13 shows a block diagram of a communications manager that supports PDCCH design for FSI in accordance with one or more aspects of the present disclosure.

FIG. 14 shows a diagram of a system including a device that supports PDCCH design for FSI in accordance with one or more aspects of the present disclosure.

FIGS. 15 and 16 show block diagrams of devices that support PDCCH design for FSI in accordance with one or more aspects of the present disclosure.

FIG. 17 shows a block diagram of a communications manager that supports PDCCH design for FSI in accordance with one or more aspects of the present disclosure.

FIG. 18 shows a diagram of a system including a device that supports PDCCH design for FSI in accordance with one or more aspects of the present disclosure.

FIGS. 19 through 21 show flowcharts illustrating methods that support PDCCH design for FSI in accordance with one or more aspects of the present disclosure.

### DETAILED DESCRIPTION

In some wireless communications systems, a user equipment (UE) may communicate with a network entity via one or more sub-bands (e.g., component carriers (CC)). For example, the network entity may configure the UE with configuration information. The UE and the network entity may communicate in accordance with the configuration information. The configuration information may indicate multiple monitoring occasions of a physical downlink control channel (PDCCH) candidate for reception of a control channel or repetitions of a control channel associated with a single carrier. The UE may perform blind decodes during the monitoring occasions. In some cases, the UE may be unable to decode a PDCCH candidate (e.g., a control channel) based on a limited frequency diversity corresponding to a search space associated with the monitoring occasions or a low aggregation level (AL) associated with the search space.

According to techniques described herein, a UE may receive configuration information (e.g., a flexible spectrum integration (FSI) configuration). The configuration information may indicate one or more sub-bands associated with one or more physical carriers aggregated in a virtual cell. For example, the FSI configuration may integrate multiple sub-bands and pool the physical resources associated with each sub-band into a single virtual cell. The virtual cell may act as a single scheduling entity (e.g., the virtual cell may be a single cell from a scheduling point of view). The FSI configuration may indicate a set of PDCCH candidates for reception of a control channel or repetitions of the control channel. The plurality of PDCCH candidates may be distributed across multiple sub-bands. The UE may perform a first set of blind decodes (e.g., in accordance with the FSI configuration during a first monitoring occasion). The first monitoring occasion may be associated with a first search space set of a first PDCCH core resource set (CORESET) in a first sub-band of the virtual cell. The UE may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space set. For example, the FSI configuration may associate a first PDCCH candidate in the first search space with a second PDCCH candidate in the second search space. In some cases, the one or more sub-bands may be one or more component carriers in a carrier aggregation configuration. In fact, the concepts described herein with respect to sub-bands and FSI may also each be applied to component carriers and carrier aggregation.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

Aspects of the disclosure are initially described in the context of wireless communications systems. Additional aspects of the disclosure are described in the context of a transport block (TB) scheduling configuration, a control channel resource configuration, a CORESET configuration, a virtual cell, and a communications timeline. Aspects of the disclosure are further illustrated by and described with reference to apparatus diagrams, system diagrams, and flowcharts that relate to PDCCH design for FSI.

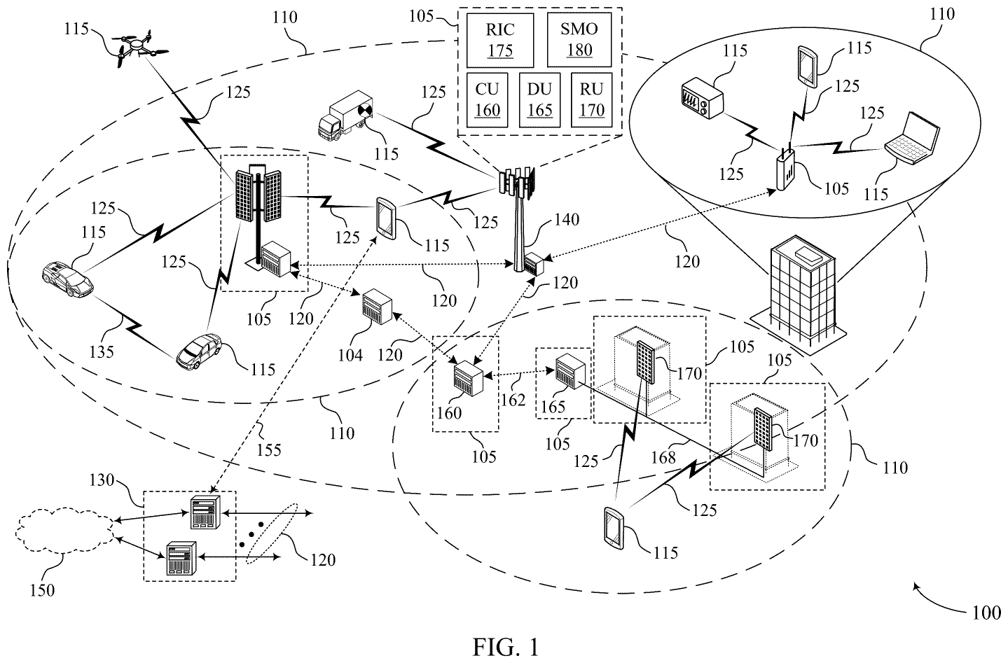

FIG. 1 shows an example of a wireless communications system 100 that supports PDCCH design for FSI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more ALs arranged in a cascaded manner. An AL for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a UE may receive configuration information (e.g., a FSI configuration). The configuration information may indicate one or more sub-bands associated with one or more physical carriers aggregated in a virtual cell. The FSI configuration may indicate a set of PDCCH candidates for reception of a control channel or repetitions of the control channel. The plurality of PDCCH candidates may be distributed across multiple sub-bands. The UE may perform a first set of blind decodes (e.g., in accordance with the FSI configuration during a first monitoring occasion). The first monitoring occasion may be associated with a first search space of a first PDCCH CORESET in a first sub-band of the virtual cell. The UE may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space. For example, the FSI configuration may associate a first PDCCH candidate in the first search space with a second PDCCH candidate in the second search space.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

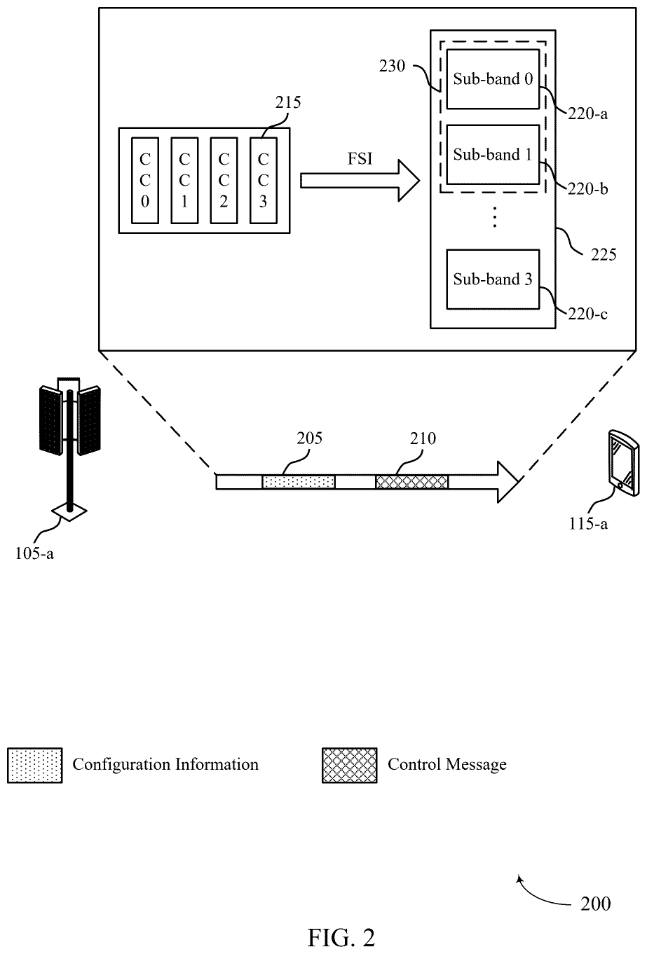

FIG. 2 shows an example of a wireless communications system 200 that supports PDCCH design for FSI in accordance with one or more aspects of the present disclosure. In some implementations, wireless communications system 200 may implement aspects of wireless communications system 100. For example, a UE 115-a may represent an example of a UE, such as the UEs 115 described with reference to FIG. 1. The network entity 105-a may represent a network entity, such as the network entity 105 described with reference to FIG. 1. The network entity 105-a may communicate with the UE 115-a via a wireless communications link. The wireless communications link may utilize carrier aggregation (e.g., carrier aggregation including one or more CCs 215) or a virtual cell 225 (e.g., a virtual cell 225 including one or more subbands 220 corresponding to one or more CCs 215 (e.g., a FSI configuration)). In some cases, the network entity 105-a may transmit configuration information 205 (e.g., the FSI configuration) to the UE 115-a. In some cases, the UE 115-a and the network entity 105-a may be pre-configured with an FSI configuration.

In some wireless communication systems, a UE 115-a may communicate with a network entity 105-a via multiple CCs 215. In some cases, the UE 115-a may utilize a carrier aggregation configuration to communicate with the network entity 105-a via the multiple CCs 215. The carrier aggregation configuration may be configured with one or more schedulers or one or more MAC entities (e.g., the network entity 105-a) that may configure each of the multiple CCs 215 separately. For example, a scheduler (e.g., the network entity 105-a) may schedule a transport block on a first CC 215. The scheduler may not schedule the transport block partially over the first CC 215 and partially over a second CC 215. That is, the resources associated with the carrier aggregation configuration may be scheduled separately per CC 215. For example, if the UE 115-a transmits a message over the first CC 215, and the message may not be decoded at the network entity 105-a. The scheduler may schedule the UE 115-a to transmit a retransmission of the message over the first CC 215 based on the carrier aggregation configuration. The scheduler may not schedule the retransmission of the message over any other CC 215 (e.g., the second CC 215) regardless of channel conditions.

In some cases, the UE 115-a may utilize a virtual cell 225 (e.g., an FSI configuration unifying PHY or MAC resources across multiple CCs 215) including one or more sub-bands 220. The sub-bands 220 may be a physical carrier (e.g., the CC 215) or a portion of a physical carrier (e.g., a portion of the CC 215). The virtual cell 225 may increase coordination between the UE 115-a and the network entity 105-a based on increasing the bandwidth available to a scheduler. Each sub-band 220 (e.g., sub-band 220-a, sub-band 220-b, and sub-band 220-c) may include the one or more CC 215. The FSI configuration may integrate the multiple CCs 215 (e.g., in the same or different sub-bands 220) to form a virtual cell 225 (e.g., a virtual carrier). For example, the FSI configuration may pool the physical resources associated with each CC 215 into a single virtual cell 225. The UE 115-a and the network entity 105-a may treat the single virtual cell 225 as a cell. The virtual cell 225 may be in a carrier aggregation configuration with other CCs 215 or other virtual cells 225. For example, the virtual cell 225 (e.g., virtual carrier) may act as one scheduling and HARQ entity (e.g., the virtual cell 225 may be a single cell from a scheduling or HARQ point of view).

In some cases, the UE 115-a may perform a blind decode in a search space set of a CORESET (e.g., core resource set). The network entity 105-a may transmit one or more control messages 210 to the UE 115-a via the search space set of the CORESET. The search space set may include one or more PDCCH candidates. In some examples, the virtual cell 225 may include a similar amount (e.g., one CC worth) of PDCCH monitoring occasions as a single CC 215 for scheduling the multiple CCs 215. The FSI configuration may provide for fewer decoding 34 attempts and a narrow radio frequency for PDCCH monitoring occasions. For example, the FSI configuration may reduce the radio frequency resources associated with PDCCH monitoring occasions when scheduling for the UE 115-a is below a threshold. The reduced radio frequency resources may reduce power consumption at the UE 115-a. The FSI configuration may unify retransmissions across sub-bands for increased frequency diversity. For example, the UE 115-a may transmit a message on a first sub-band 220-a associated with a first CC 215, and the UE 115-a may retransmit the message on a second sub-band 220-b associated with a second CC 215.

In some cases, the scheduler may schedule a TB across aggregated sub-bands 220 in accordance with one or more configurations (e.g., flavors). In some examples, the scheduler may schedule the TB across multiple sub-bands 220. For example, the scheduler may Integrate the small (e.g., 5 MHz, 10 MHZ, or 20 MHz) and scattered FDD channels as one large virtual carrier with a single-TB scheduling. Scheduling the TB across multiple sub-bands may increase the frequency diversity associated with the TB. In some examples, the scheduler may schedule multiple TBs, where each TB may be contained within a sub-band 220. For example, the scheduler may schedule multiple TBs with a single CC 215 PDCCH control resources for large, aggregated bandwidth (e.g., 100 MHz).

In some cases, the FSI configuration may enable bandwidth adaptation using BWP mechanisms. For example, an active BWP 230 may include the sub-band 220-a and the sub-band 220-b. The sub-band 220-a and the sub-band 220-b may be discontinuous (e.g., the active BWP 230 may be a non-contiguous active BWP 230). The UE 115-a or the network entity 105-a may adapt the active BWP 230 to increase or decrease the resources allocated for communication. For example, a BWP adaptation may provide low latency adaptation based on a radio frequency bandwidth and configured measurements associated with the UE 115-a.

According to techniques described herein, a UE 115-a may receive configuration information 205 (e.g., a FSI configuration). The configuration information 205 may indicate one or more sub-bands associated with one or more physical carriers aggregated in a virtual cell. The FSI configuration may indicate a set of PDCCH candidates for reception of a control channel or repetitions of the control channel. The plurality of PDCCH candidates may be distributed across multiple sub-bands. The UE 115-a may perform a first set of blind decodes (e.g., in accordance with the FSI configuration during a first monitoring occasion). The first monitoring occasion may be associated with a first search space of a first PDCCH CORESET in a first sub-band of the virtual cell. The UE 115-a may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space. For example, the FSI configuration may associate a first PDCCH candidate in the first search space with a second PDCCH candidate in the second search space.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

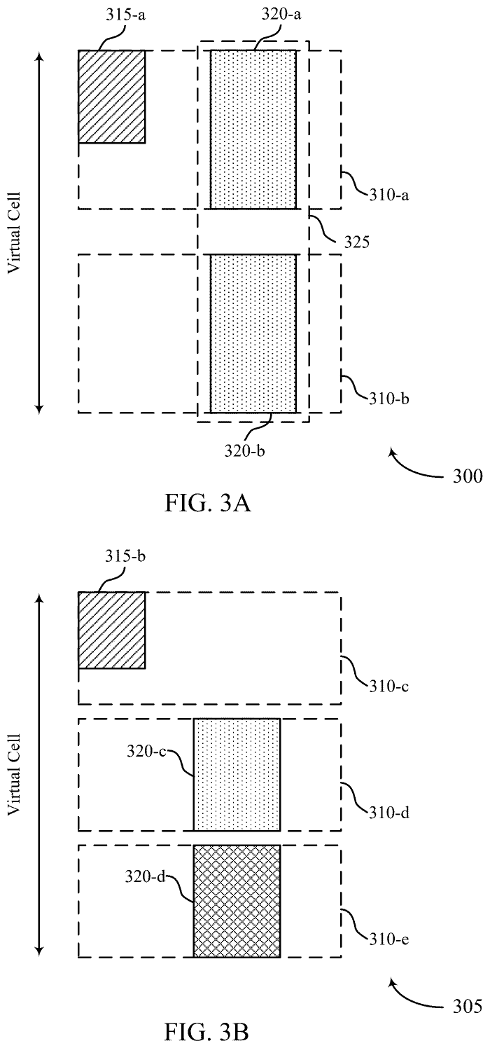

FIG. 3A shows an example of a TB scheduling configuration 300 that supports PDCCH design for FSI in accordance with one or more aspects of the present disclosure. In some examples, TB scheduling configuration 300 may implement aspects of, or be implemented by aspects of, the wireless communications system 100 or the wireless communications system 200. The TB scheduling configuration 300 may be performed by a scheduler of a network entity 105. For example, the scheduler may schedule a TB for a UE 115 in accordance with the TB scheduling configuration 300. The network entity 105 and the UE 115 may be examples of a network entity 105 and a UE 115 as described with reference to FIGS. 1 and 2.

In some cases, the scheduler may schedule a TB across multiple sub-bands. The scheduler may schedule the TB across a multiple sub-band based 310 based on the bandwidth of the sub-bands 310 not exceeding a threshold. The FSI configuration may include a single CORESET 315-a for all sub-bands 310 in a virtual cell. The FSI configuration may schedule or map a single PxSCH (e.g., PDSCH or PUSCH) across multiple sub-bands 310. For example, a first sub-band 310-a may include a CORESET 315-a for scheduling the sub-bands 310 in a virtual cell. The first sub-band 310-a (e.g., an anchor sub-band 220) may include PDCCH candidates in the CORESET 315-a. In other words, the FSI configuration may include a single CC PDCCH blind detection on the anchor sub-band. Each TB may be mapped onto an active BWP 325 (e.g., a non-contiguous BWP 325) within a virtual cell. For example, the scheduler may schedule a single PxSCH via a single downlink control information (DCI) message. The single PxSCH may include non-contiguous communication resources 320 (e.g., communication resource 320-a on the first sub-band 310-a and communication resource 320-b on the second sub-band 310-b). The FSI configuration may map TBs across SBs with a code block (CB) level interleaving. For example, the first sub-band may contain a first subset of CBs of the TB and the second sub-band may contain a second subset of CBs of the TB. The CB level interleaving may be beneficial in low-band spectrum with small channels.

In some cases, a TB spanning different sub-bands 310 may be scheduled with a single set of link parameter (e.g., a modulation order and a rank). In some cases, the TB spanning different sub-bands 310 may be scheduled with different link parameters. For example, a first portion of the TB mapped to the communication resources 320-a may have a first modulation order and a first rank. A second portion of the TB mapped to the communication resources 320-b may have a second modulation order and a second rank. The first modulation order and the first rank may be different than the second modulation order and the second rank based on channel conditions associated with the first sub-band 310-a and channel conditions associated with the second sub-band 310-b. The different link parameters may change the data path (e.g., TB size, limited buffer rate-matching (LBRM), sub-band performance management (SBPM), or symbol and rank mapping). Additionally, or alternatively, the UE pipeline may be based on the different link parameters.

In some cases, the TB may span sub-bands 310 of the same sub-carrier spacing (SCS) and sub-bands 310 of the same co-located deployment. In some cases, the FSI configuration may integrate CCs across sub-bands 310 with different SCS (e.g., to replace time division duplex and FDD carrier aggregation) and non-collocated sub-bands 310. For example, the TB may span sub-bands 310 of different SCS and sub-bands 310 of the non-located deployments.

According to techniques described herein, a UE 115 may receive configuration information (e.g., a FSI configuration). The configuration information may indicate one or more sub-bands associated with one or more physical carriers aggregated in a virtual cell. The FSI configuration may indicate a set of PDCCH candidates for reception of a control channel or repetitions of the control channel. The plurality of PDCCH candidates may be distributed across multiple sub-bands. The UE 115 may perform a first set of blind decodes (e.g., in accordance with the FSI configuration during a first monitoring occasion). The first monitoring occasion may be associated with a first search space of a first PDCCH CORESET in a first sub-band of the virtual cell. The UE 115 may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space. For example, the FSI configuration may associate a first PDCCH candidate in the first search space with a second PDCCH candidate in the second search space.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

FIG. 3B shows an example of a TB scheduling configuration 305 that supports PDCCH design for FSI in accordance with one or more aspects of the present disclosure. In some examples, TB scheduling configuration 305 may implement aspects of, or be implemented by aspects of, the wireless communications system 100, the wireless communications system 200, or the TB scheduling configuration 300. The TB scheduling configuration 300 may be performed by a scheduler of a network entity 105. For example, the scheduler may schedule a TB for a UE 115 in accordance with the TB scheduling configuration 300. For example, an FSI configuration may configure a scheduler (e.g., the scheduler as described with reference to FIG. 2) to schedule one or more TBs via a virtual cell. The virtual cell may include a lower band (e.g., narrow band) sub-band 310-c and one or more wide-band carriers in higher frequency ranges (e.g., a sub-band 310-d and a sub-band 310-e). The network entity 105 and the UE 115 may be examples of a network entity 105 and a UE 115 as described with reference to FIGS. 1-3A.

In some cases, the scheduler may schedule a TB for a single sub-band 310. The scheduler may schedule the TB across a single sub-band based 310 based on the bandwidth of the sub-bands 310 exceeding a threshold. For example, each TB may be mapped onto a single sub-band 310 of the virtual cell. A first sub-band 310-c (e.g., a lower band anchor sub-band 310) may include a CORESET 315-b. The FSI configuration may include a single CC PDCCH blind detection. The single CC PDCCH blind detection may schedule multiple TBs on different sub-bands 310. For example, the scheduler may schedule a first TB on a first set of communication resources 320-c of the second sub-band 310-d (e.g., PxSCH 1 may be scheduled by a multi sub-band (mSB) DCI). The scheduler may schedule a second TB on a second set of communication resources 320-d of the third sub-band 310-e (e.g., PxSCH N may be scheduled by the mSB DCI). The scheduler may schedule the first TB and the second TB via one or more DCI messages. In other words, the FSI configuration may enable mSB scheduling DCI (e.g., mSB DCI). In some cases, the scheduler may schedule a retransmission of the first TB originally transmitted via the second sub-band 310-d on a different sub-band 310 (e.g., the third sub-band 310-e).

The scheduler may schedule the TB for a single sub-band 310 based on large, aggregated channel band widths associated with the sub-bands 310. The scheduler may achieve frequency diversity in the single sub-band 310 (e.g., cross sub-band diversity may not be utilized). The FSI configuration may support both intra-band and inter-band scenarios. For example, the scheduler may schedule a first TB for a single sub-band 310-d. The scheduler may schedule a second TB across multiple sub-bands 310 (e.g., across the sub-band 310-d and the sub-band 310-e), as described with reference to FIG. 3A. Aggregation or integration may include different numerologies.

In some cases, the UE 115 may not support self CC scheduling. Frequency diversity across HARQ transmissions may be achieved based on the virtual cell (e.g., virtual carrier) being a single HARQ entity.

The FSI configuration may include a PDCCH configuration. In some cases, the FSI configuration may include a localized PDCCH for better UE power saving. For example, the UE 115 may monitor a CORESET 315 for control signals (e.g., PDCCH). The control signals may schedule a TB for transmission in one or more sub-bands 310. For example, the UE 115 may receive a DCI message via a narrow band radio frequency for control channel monitoring in the first sub-band 310-c during a first slot (e.g., Slot n). The DCI message may schedule a first TB for transmission in one or more sub-bands 310 (e.g., a sub-band 310-d or an active BWP 325 including multiple sub-bands 310) during a second slot (e.g., Slot m) for cross-slot scheduling. The one or more sub-bands 310 may be a wide-bandwidth radio frequency for a shared channel. In some cases, the FSI configuration may include a distributed PDCCH for deep coverage scenarios. For example, the FSI configuration may distribute control channel resources across multiple sub-bands to increase frequency diversity. The increased frequency diversity may increase coverage at the UE 115.

According to techniques described herein, a UE 115 may receive configuration information (e.g., a FSI configuration). The configuration information may indicate one or more sub-bands associated with one or more physical carriers aggregated in a virtual cell. The FSI configuration may indicate a set of PDCCH candidates for reception of a control channel or repetitions of the control channel. The plurality of PDCCH candidates may be distributed across multiple sub-bands. The UE 115 may perform a first set of blind decodes (e.g., in accordance with the FSI configuration during a first monitoring occasion). The first monitoring occasion may be associated with a first search space of a first PDCCH CORESET in a first sub-band of the virtual cell. The UE 115 may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space. For example, the FSI configuration may associate a first PDCCH candidate in the first search space with a second PDCCH candidate in the second search space.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

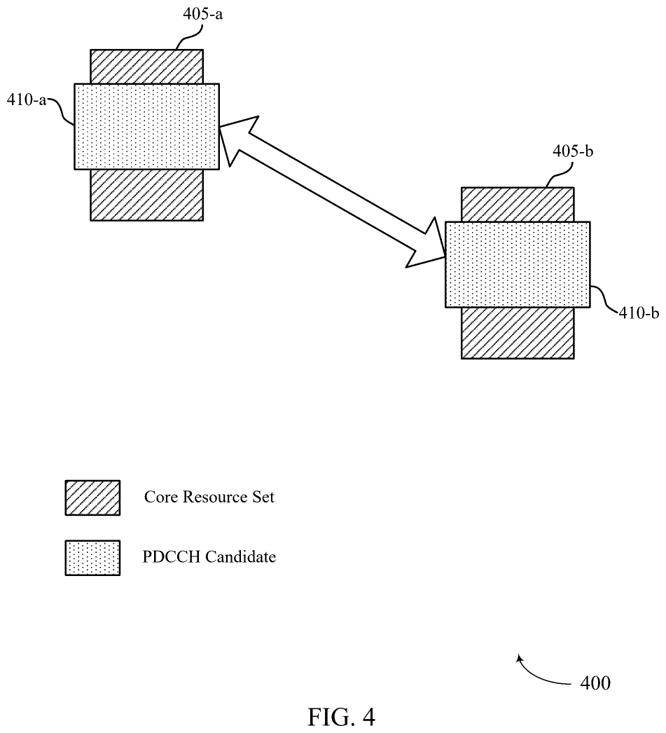

FIG. 4 shows an example of a control channel resource configuration 400 that supports PDCCH design for FSI in accordance with one or more aspects of the present disclosure. In some examples, control channel resource configuration 400 may implement aspects of, or be implemented by aspects of, the wireless communications system 100, the wireless communications system 200, the TB scheduling configuration 300, or the TB scheduling configuration 305. A network entity 105 may configure a UE 115 with an FSI configuration (e.g., the FSI configuration as described with reference to FIG. 2). The FSI configuration information may be based on the control channel resource configuration 400. The network entity 105 and the UE 115 may be examples of a network entity 105 and a UE 115 as described with reference to FIGS. 1-3B.

In some cases, the network entity 105 may configure a UE-specific CORESET 405 (e.g., core resource set) within the channel bandwidth. If channel bandwidth is large, the UE-specific CORESET 405 may be relatively large. The UE-specific CORESET 405 may include distributed resource element group (REG) to CCE mapping. The large channel bandwidth may enable frequency diversity gains. The network entity 105 may configure a first CORESET 405 (e.g., CORESET0). A resource allocation associated with the first CORESET 405 may be dependent on a pair of SCSs for a synchronization signal block (SSB) and PDCCH. Additionally, or alternatively, the resource allocation associated with the first CORESET 405 may be based on the band of operation (e.g., 96 resource blocks (RBs) of 15 kHz may be a threshold (e.g., maximum size) for the first CORESET 405).

In some cases, the FSI configuration may include multiple transmission configuration indicator (TCI) state PDCCH repetition. The multiple TCI state PDCCH repetition may increase communications reliability between the UE 115 and the network entity 105. For example, the network entity 105 may transmit PDCCH and PDCCH repetitions in different search space sets corresponding to different CORESETs. The network entity 105 may transmit the PDCCH and PDCCH repetitions with different TCI states. For example, a first CORESET 405-a may include one or more search spaces, and a second CORESET 405-b may include one or more search spaces. The first CORESET 405-a may be associated with a first TCI state, and the second CORESET 405-b may be associated with a second TCI state. The network entity 105 may indicate an association between a first search space corresponding to a first CORESET 405-a and a second search space corresponding to a second CORESET 405-b. A first PDCCH candidate 410-a of the first search space may be associated with a second PDCCH candidate 410-b of the second search space based on the association between the first search space and the second search space. For example, the first PDCCH candidate 410-a and the second PDCCH candidate 410-b may be PDCCH repetitions of the same PDCCH. The UE 115 may monitor the first search space of the first CORESET 405-a. The UE 115 may attempt to decode the first PDCCH candidate 410-a. If the UE 115 is unable to decode the first PDCCH candidate 410-a, the UE 115 may monitor the second search space and attempt to decode the second PDCCH candidate 410-b. The UE 115 may combine the first PDCCH candidate 410-a and the second PDCCH candidate 410-b to improve the probability of successfully decoding the PDCCH candidates.

The associated PDCCH candidates 410 may include the same DCI payload, the same AL, and the same coded bits in two PDCCH repetitions (e.g., a first PDCCH repetitions associated with the first PDCCH candidate 410-a and a second PDCCH repetitions associated with the second PDCCH candidate 410-b). Two PDCCH candidates 410 may be explicitly linked (e.g., UE 115 may be aware of linkage before decoding the PDCCH candidates 410). The network entity 105-a may configure a search space set configuration to facilitate linkage. The search space set configuration may enable a one-to-one mapping between monitoring occasions and PDCCH candidates 410. For example, a first monitoring occasion associated with the first search space set may be linked to a first monitoring occasion associated with the second search space set, and the second monitoring occasion associated with the first search space set may be linked to the second monitoring occasion associated with the second search space set.

In some cases, repetition may be limited to one slot of one carrier. For example, a first repetition associated with a first search space and a second repetition associated with a second search space may be in the same slot of the same carrier. Frequency diversity associated with the PDCCH repetitions may be expected via TCI cycling (e.g., mTRP mode). The coverage associated with the PDCCH repetitions may be extended increasing AL with a straight path (sTRP) based on the PDCCH repetitions. In some cases, the quantity of repetitions may be limited to two repetitions. In some cases, repeated PDCCH candidates may be multiplexed (e.g., FDM or TDM) if the repeated PDCCH candidates are associated with different CORESETs (e.g., the network entity 105 capabilities and UE 115 capabilities for handling different beams concurrently are supported). In some cases, a network entity 105 may be unable to repeat PDCCH candidates 410 within one core resources set based on a hashing function. The hashing function may map the PDCCH candidates 410 to the same set of CCEs.

The linked search space sets may be associated with an identical quantity of PDCCH candidates the UE 115 is configured to monitor for (e.g., M_{s,max}^{(L)}). The CCE indices may be the same if the repetition PDCCH candidates 410 are within the same CORESET 405. For example, repetition PDCCH candidates 410 in the same CORESET 405 may be mapped to the same CCE indices. The network entity 105 may transmit one of the repetition PDCCH candidates 410 at the communication resources associated with the same CCE indices. The network entity 105 may not transmit the other repetition PDCCH candidates 410 based on the other repetition PDCCH candidates 410 sharing the same communication resources (e.g., the other repetition PDCCH candidates 410 may be associated with the same CCE indices).

That is, a hashing function may not be capable of mapping repetition PDCCH candidates 410 candidates within one CORESET. The hashing function identifies the CCE indices to be monitored, and the hashing function may be based on a quantity of PDCCH candidates the UE is configured to monitor for in a respective search space set. If the quantity is the same for linked search space sets (e.g., the linked search space sets are associated with the same M_{s,max}^{(L)}), then the input to the hashing function may not change and the output CCE indices for one or more repetition PDCCH candidates may be the same.

According to techniques described herein, the FSI configuration may provide frequency diversity gain by extending control resources across different sub-bands (e.g., in the same manner as scheduling a TB across sub-bands). In some cases, extending control resources across different sub-bands may be based on a bandwidth associated with the sub-bands. For example, extending control resources across different sub-bands may be limited to integration across small sub-bands (e.g., FDD and FDD or some of the FDD and TDD FSIs). In some cases, extending control resources across different sub-bands may improving link failures (e.g., in FR2). In some cases, cell search or access (e.g., system information block one (SIB1) PDCCH, paging, or random access procedure) may be extended across different sub-bands.

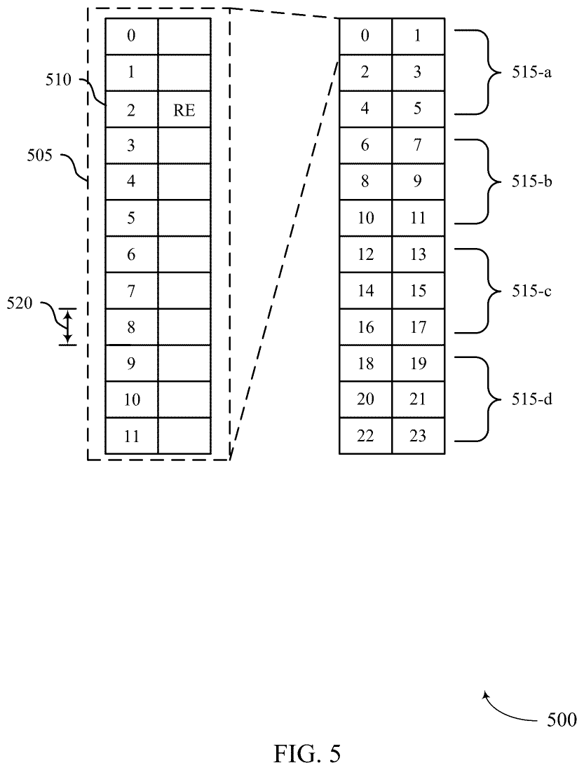

FIG. 5 shows an example of a CORESET configuration 500 that supports PDCCH design for FSI in accordance with one or more aspects of the present disclosure. In some examples, CORESET configuration 500 may implement aspects of, or be implemented by aspects of, the wireless communications system 100, the wireless communications system 200, the TB scheduling configuration 300, the TB scheduling configuration 305, or the control channel resource configuration 400. A network entity 105 may configure a UE 115 with an FSI configuration (e.g., the FSI configuration as described with reference to FIG. 2). The FSI configuration information may be based on the CORESET configuration 500. The network entity 105 and the UE 115 may be examples of a network entity 105 and a UE 115 as described with reference to FIGS. 1-4. The CORESET configuration 500 may include one or more CCEs 515 (e.g., CCE 515-a, CCE 515-b, CCE 515-c, and CCE 515-d), which may include one or more resource elements 510 (REs).

In some cases, a set of REG 505 may be mapped to a set of CCE 515. For example, a REG 505 may include multiple 510. The REs 510 may be associated with an SCS 520. In some cases, the REG 505 may be associated with a preconfigured demodulation reference signal (DMRS) pattern (e.g., DMRS pattern agreed). The DMRS pattern illustrated in FIG. 5 may show the DMRS pattern for a physical broadcast channel (PBCH). All REG 505 may include the same DMRS density. A first RE 510 (e.g., an RE of index 0 as illustrated in FIG. 5) may be a DMRS RE 510. A second RE 510 (e.g., an RE of index 2) may be a control RE 510.

As an illustrative example, a CCE 515-a may be mapped to six REGs 505. In some examples, mapping of a PDCCH candidate with AL four (e.g., a CORESET including 4 CCEs) into a CORESET of two symbols without interleaving may map six continuous REGs 505 (e.g., REG 0, REG 1, REG 2, REG 3, REG 4, and REG 5) to a CCE 515 (e.g., CCE 515-a).

In some examples, mapping of a PDCCH candidate with AL of four into a CORESET of two symbols with interleaving and with an REG bundle size of six may map the CCE 515 to a first REG bundle (e.g., a REG bundle include REG 0, REG 1, REG 2, REG 3, REG 4, and REG 5). The REG bundles may be interleaved in the frequency domain with CORESET resources. For example, the first REG bundle may occupy a first set of CORESET resources that may be discontinuous from a second REG bundle occupying a second set of CORESET resources. The REG bundles may be interleaved in the frequency domain in accordance with a configured parameter (e.g., “A” value (2, 3, 6)). The REG bundles may be cyclically shifted in accordance with a configurable identifier (ID), and the REG bundles may be mapped onto PHY resources of a PHY CORESET. The PHY resources may be distributed in disjoint REG bundles.

As an illustrative example, if the configured parameter is two and there is no cyclic shift or CORESET PHY mapping in sets of REG bundles (e.g., the set of REG bundles discontinuous in frequency), a first CCE 515-a may be associated with a first REG bundle (e.g., an REG bundle including REG 0, REG 1, REG 2, REG 3, REG 4, and REG 5) and a second CCE 515-c may be associated with a second REG bundle disjoint from the first REG bundle (e.g., a REG bundle including REG 12, REG 13, REG 14, REG 15, REG 16, and REG 17).

In some examples, mapping of PDCCH with AL of four into a CORESET of two symbols with interleaving and with REG bundle size equal to the coreset length may map a CCE 515 to a REG bundle (e.g., a REG bundle including REG 0, REG 1, REG 8, REG 9, for a coreset length of 4). In some cases, the interleaved REGs may be associated with a configured parameter value of 3 and no cyclic shift. A CORESET PHY mapping in a set of REG bundles may be discontinue in frequency.

According to techniques described herein, a UE 115 may receive configuration information (e.g., a FSI configuration). The configuration information may indicate one or more sub-bands associated with one or more physical carriers aggregated in a virtual cell. The FSI configuration may indicate a set of PDCCH candidates for reception of a control channel or repetitions of the control channel. The plurality of PDCCH candidates may be distributed across multiple sub-bands. The UE 115 may perform a first set of blind decodes (e.g., in accordance with the FSI configuration during a first monitoring occasion). The first monitoring occasion may be associated with a first search space of a first PDCCH CORESET in a first sub-band of the virtual cell. The UE 115 may perform a second set of blind decodes (e.g., in accordance with the FSI configuration) during a second monitoring occasion. The second monitoring occasion may be associated with a second search space set of a second PDCCH CORESET in a second sub-band of the virtual cell. The FSI configuration may associate the first search space set with the second search space. For example, the FSI configuration may associate a first PDCCH candidate in the first search space with a second PDCCH candidate in the second search space.

In some cases, the first PDCCH CORESET and the second PDCCH CORESET may be different, and the first search space set and the second search space set may be different. In some cases, the first PDCCH CORESET and the second PDCCH CORESET may be different, and the first search space set and the second search space set may be portions of a same search space set. In some cases, the first PDCCH CORESET and the second PDCCH CORESET may be portions of a same PDCCH CORESET, and the same PDCCH CORESET may include a first resource block (RB) set in the first sub-band and a second RB set in the second sub-band.

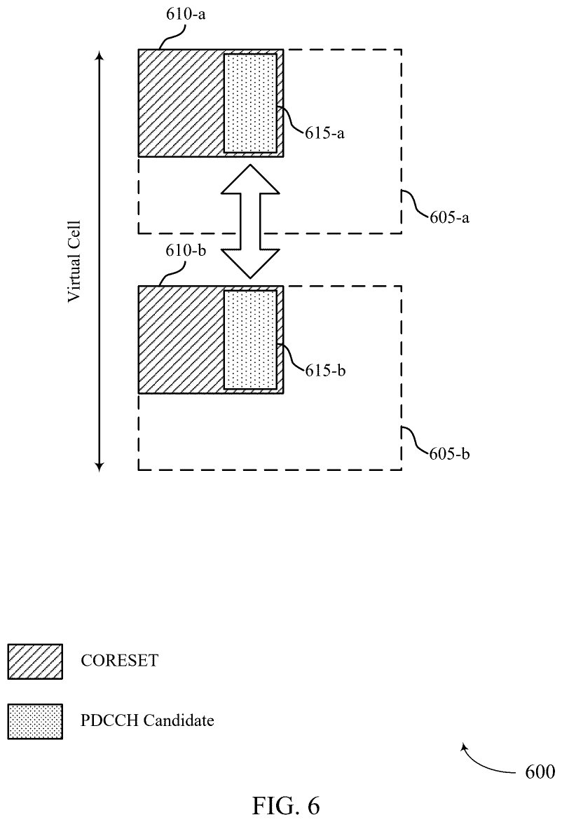

FIG. 6 shows an example of a virtual cell 600 that supports PDCCH design for FSI in accordance with one or more aspects of the present disclosure. In some examples, virtual cell 600 may implement aspects of, or be implemented by aspects of, the wireless communications system 100, the wireless communications system 200, the TB scheduling configuration 300, the TB scheduling configuration 305, the control channel resource configuration 400, or the CORESET configuration 500. A virtual cell 600 (e.g., described with reference to FIG. 2) may represent communication resources associated with a UE 115 and a network entity 105. The network entity 105 and the UE 115 may be examples of a network entity 105 and a UE 115 as described with reference to FIGS. 1-5. The virtual cell may include a first sub-band 605-a and a second sub-band 605-b. In some cases, the virtual cell may include additional sub-bands 605 (not shown). The first sub-band 605-a may include a first CORESET 610-a (e.g., core resource set), and the second sub-band 605-b may include a second CORESET 610-b.

In some cases, the FSI configuration may increase PDCCH reliability for FIS. For example, the FSI configuration may provide frequency diversity for PDCCH. In some examples, the network entity 105 may configure PDCCH repetitions across different sub-bands 605 as illustrated in FIG. 6. The PDCCH repetitions may increase the AL. In some cases, the FSI configuration may include separate DCI payload rate matching per repetition. In some cases, the network entity 105 may configure joint DCI payload rate matching. For example, a first search space may be associated with a first PDCCH repetition and the second search space may be associated with a second PDCCH repetition. A first DCI may be mapped to a first PDCCH candidate 615-a in the first CORESET 610-a and the first DCI may be mapped to a second PDCCH candidate 615-b in the second CORESET 610-b. In some cases, the DCI may be encoded based on the first PDCCH candidate 615-a in the first CORESET 610-a (e.g., separate DCI payload rate matching per repetition). In some cases, the DCI may be encoded based on the first PDCCH candidate 615-a in the first CORESET 610-a and the second PDCCH candidate 615-b in the second CORESET 610-b (e.g., join DCI payload rate matching).

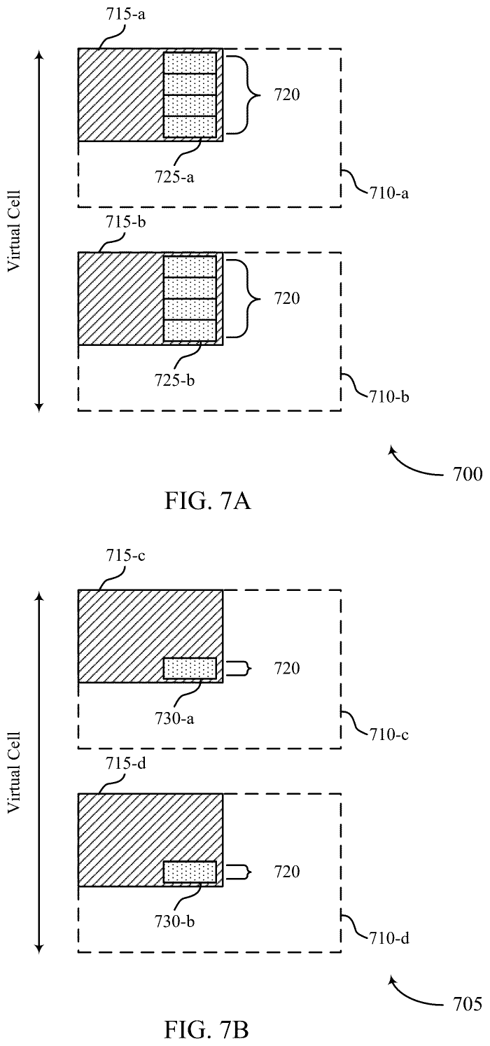

In some examples, the FSI configuration may distribute REG bundles or CCEs across different sub-bands 605, as described with reference to FIG. 7. In some cases, the distribution of REG bundles may be a non-uniform distribution. In some cases, the distribution of REG bundles may be uniform across the sub-bands 605 (e.g., distributed, on a per-sub-band basis, in accordance with AL/n, where n is the quantity of sub-bands 605). The distributed REG bundles may be associated with joint DCI payload rate matching.

For example, the first sub-band 605-a may include a first CORESET 610-a. The first CORESET 610-a may include a first search space set. The first search space set may include a first PDCCH candidate 615-a associated with an AL. The second sub-band 605-b may include a second CORESET 610-b. The second CORESET 610-b may include a second search space set. The second search space set may include a second PDCCH candidate 615-b the same AL as the first PDCCH candidate 615-a. The FSI configuration may link (e.g., pair) the first PDCCH candidate 615-a with the second PDCCH candidate 615-b. The link between the first PDCCH candidate 615-a and the second PDCCH candidate 615-b may increase the effective AL associated with the first PDCCH candidate 615-a and the second PDCCH candidate 615-b. For example, if a first AL associated with the first PDCCH candidate 615-a is L and a second AL associated with the second PDCCH candidate 615-b is L, an AL associated with the first PDCCH candidate 615-a and the second PDCCH candidate 615-b may increase to 2L.

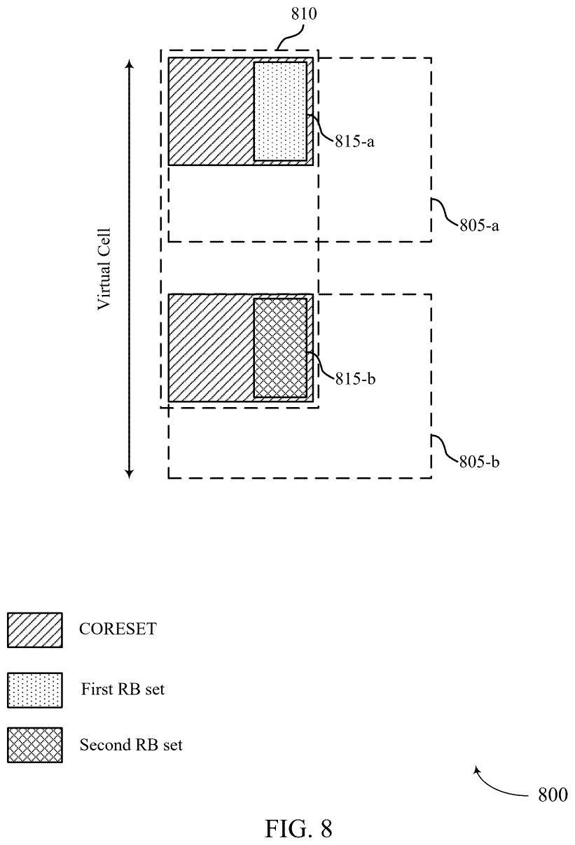

In some examples, the FSI configuration may include repeated PDCCH candidates. The repeated PDCCH candidates may include REG bundles or CCEs distributed across sub-bands 605 (e.g., for achieving higher AL), as described with reference to FIG. 8.

The FSI configuration may include a CORESET configuration. In some cases, the CORESET 610 may be configured as contiguous or non-contiguous in the frequency domain (e.g., a maximum of four segments if precoder granularity is all consecutive RBs). The CORESET configuration may include one or more orthogonal frequency-division multiplexing (OFDM) symbols. The CORESET configuration may include both interleaved and non-interleaved mapping schemes, as described with reference to FIG. 5.

In some cases, the FSI configuration may include separate CORESETs per sub-band 605. The FSI configuration may include different CORESETs per sub-band 605 based on one non-contiguous wide-band BWP defined across the entire virtual carrier. In some cases, the FSI configuration may include separate CORESETs per BWP per sub-band 605 based on different sub-bands 605 including different BWPs (e.g., similar to carrier aggregation). The CORESETs may be associated with the same or different QCL sources based on the CORESETs being in different sub-bands 605. In some cases, a wide-band CORESET may be mapped to multiple sub-bands 605. The wide-band CORESET with resources in different sub-bands 605 may include different QCL sources.

In some cases, the FSI configuration may include a CORESET 610 per sub-band 605, and a search space sets per CORESET 610, as illustrated in FIG. 6. The FSI configuration may include the same numerology across sub-bands 605.

The FSI configuration may include multiple CORESETs 610 each associated with a search space set. For example, n sub-bands (e.g., n<=m where m may be the total quantity of sub-bands 605 forming the virtual carrier), and n CORESETs 610 each associated with search space sets. In some cases, there may be a linkage between search space sets of the CORESETs configured on different sub-bands 605. Additionally, or alternatively, there may be a one-to-one mapping between monitoring occasions of different search spaces of different CORESETs 610. For example, a first search space set associated with the first CORESET 610-a may be link to a second search space set associated with the second CORESET 610-b.

In some cases, up to a threshold quantity (e.g., 39) of search space set indices may be used across different BWPs of the same CC, and indexing may not be unique across different CCs. In some cases, search space set indexing may be configured (e.g., may remain) non-unique across sub-bands 605. In some cases, to enable PDCCH candidate repetition, the linkage may be per group of PDCCH candidates 615 with mapping between search space sets and sub-bands 605. For example, the first PDCCH candidate 615-a may be associated with a first sub-band index (e.g., a first sub-band index associated with the first sub-band 605-a), and the second PDCCH candidate 615-b may be associated with a second sub-band index (e.g., a second sub-band index associated with the second sub-band 605-b). The first PDCCH candidate 615-a may be associated with a first search space set index and sub-band index (e.g., SS Set 1 (CORESET i with TCI state 1) in SB n). The first PDCCH candidate 615-a may be mapped to the second PDCCH candidate 615-b based on a search space index and sub-band index (e.g., SS Set 2 (CORESET j with TCI state 2) in SB m) associated with the second PDCCH candidate 615-b. The linkage may represent PDCCH repetitions between the two CORESETs 610.

In some cases, mapping of REG bundle to CCE and mapping of PDCCH candidates to CCEs may be done independently per CORESET 610 per sub-band 605. For example, CORESET configuration may be independent across sub-bands 605. The first CORESET 610-a may be configured independently of the second CORESET 610-b. Configuration limitations for the PDCCH candidates 615 (e.g., limitations for PDCCH candidates 615 to include the same AL, same DCI payload, same quantity of coded bits, or the same SS set type) may be enforced for PDCCH repetitions.

The UE 115 may perform PDCCH candidate dropping in case of overbooking. In some cases, all CORESETs 610 or search space sets of the virtual carrier may be on a primary cell (PCell) if the virtual carrier is aggregated with other carriers. Dropping may be based on the ordering of sub-band indices and search space set indices. In some examples, within one PDCCH repetition bundle, some of the PDCCH candidates 615 may be dropped. The effective repetition factor may be smaller than the nominal value based on the dropping. In some examples, the UE 115 may index all PDCCH candidates across sub-bands (e.g., repeated PDCCH candidates have one index together), and the UE 115 may perform dropping based on the PDCCH candidate indexing. The dropping may be based on a threshold CCE budget or a threshold blind decode budget.

The UE 115 may perform one or more blind decodes, as described with reference to FIG. 2. The UE 115 may perform blind decode counting associated with the one or more blind decodes. For example, the UE 115 may report a quantity (e.g., required number) of blind decodes for the two linked PDCCH candidates 615. The UE 115 may be associated with a UE capability corresponding to PDCCH candidate values of 2 or 3. The UE 115 may perform individual decoding (e.g., selection diversity), soft combining, or both. For example, a PDCCH candidate value of 3 may be associated with trying 3 blind decodes at the UE 115. Additionally, or alternatively, a PDCCH candidate value of 3 may improve handling of a log likelihood ratio (LLR) buffer. The UE 115 may try one blind decode after combining two PDCCH candidates 615. That is, the UE 115 may buffer LLRs across time.

For example, the UE 115 may receive the first PDCCH candidate 615-a on the first sub-band 605-a, and the UE 115 may buffer the PDCCH candidate 615-a. The UE 115 may receive the second PDCCH candidate 615-b on the second sub-band 605-b. The UE 115 may attempt to decode the first PDCCH candidate 615-a and the second PDCCH candidate 615-b together based on a linkage between the PDCCH candidates 615. The UE 115 may be associated with a UE capability corresponding to a PDCCH candidate value of 3 based on combining the PDCCH candidates 615.

In some cases, for FSI, the quantity of PDCCH candidate repetitions a UE may receive (e.g., choices for a UE) may increase. With n sub-bands and n repetition PDCCH candidates, each separate grouping (e.g., pair or tuple) may be considered. Instead of listing all possibilities, the UE capability may cover a subset of possibilities. For example, n and n+1 may cover selection and combining all repetition PDCCH candidates. For example, n+1 may cover a blind decode and the buffering for all PDCCH LLRs.

The FSI configuration may be used for PDCCH repetition across sub-bands 605. An effective AL may be based on the AL of each PDCCH candidate 615 and a quantity of sub-bands associated with the PDCCH repetition (e.g., AL=n*L if each PDCCH candidate has AL=L and repeated on n sub-bands). The FSI configuration may be used for uniformly distributing resources of a given AL across sub-bands 605 (e.g., not increasing overhead). If the target is to achieve a given AL (e.g., AL=L), the FSI configuration may form PDCCH candidates of a second AL (e.g., AL=L/n) over each of the n sub-bands. For example, the first PDCCH candidate 615-a may be configured with a first AL (e.g., AL=L/2), and the second PDCCH candidate 615-b may be configured with the first AL (e.g., AL=L/2). The AL across the sub-band 605-a and the sub-band 605-b may achieve a target AL (e.g., AL=L) based on the first AL associated with the first PDCCH candidate 615-a and the second PDCCH candidate 615-b.

Depending on the channel or interference condition, a non-uniform distribution may be beneficial. For example, the first PDCCH candidate 615-a may be configured with a first AL, and the second PDCCH candidate 615-b may be configured with a second AL. The first AL may be different than the second AL.

Non-uniform distribution may be achieved by linking PDCCH candidates of different AL across different sub-bands 605 or search space sets. For example, an AL=8 may be obtained by linking a first AL=4, a second AL=2, a third AL=1, and a fourth AL=1 across 4 different sub-bands 605, CORESET 610, or search space sets. In some examples, a UE 115 may be monitor for new AL values. In some examples, a UE 115 may monitor for AL values associated with a distribution which may be limited to the set of AL values defined for a regular PDCCH monitoring operation. PDCCH candidate mapping (e.g., hashing function) may be done per CORESET 610, sub-band 605, or search space set separately. The UE 115 may perform one blind decode once the UE 115 receives all resources associated with a given PDCCH candidate 615. For example, the UE 115 may perform one blind decode after receiving both the first PDCCH candidate 615-a and the second PDCCH candidate 615-b.

The network entity 105 may indicate a choice between PDCCH repetition and wide-band PDCCH candidates. In some examples, the UE 115 may receive an indication (e.g., via RRC signaling) indicating the FSI configuration includes PDCCH repetition across sub-bands 605. In some examples, the UE 115 may receive an indication (e.g., via RRC signaling) indicating the FSI configuration includes wide-band PDCCH candidates, as described with reference to FIGS. 7A, 7B, and 8.

FIG. 7A shows an example of a virtual cell 700 that supports PDCCH design for FSI in accordance with one or more aspects of the present disclosure. In some examples, virtual cell 700 may implement aspects of, or be implemented by aspects of, the wireless communications system 100, the wireless communications system 200, the TB scheduling configuration 300, the TB scheduling configuration 305, the control channel resource configuration 400, the CORESET configuration 500, or the virtual cell 600. A virtual cell 700 (e.g., described with reference to FIG. 2) may represent communication resources associated with a UE 115 and a network entity 105. The network entity 105 and the UE 115 may be examples of a network entity 105 and a UE 115 as described with reference to FIGS. 1-6. The virtual cell may include a first sub-band 710-a and a second sub-band 710-b. In some cases, the virtual cell may include additional sub-bands 710 (not shown). The first sub-band 710-a may include a first CORESET 715-a (e.g., core resource set), and the second sub-band 710-b may include a second CORESET 715-b.

In some cases, the FSI configuration may include a CORESET 715 per sub-band 710, and search space sets may be associated with multiple CORESETs, as illustrated in FIG. 7A. A PDCCH candidate associated with a first AL may be distributed across sub-bands. For example, As part of RRC configuration, a search space set 720 may be associated with multiple CORESETs. The CORESETs may be in different sub-bands 710. For example, a first CORESET 715-a may be in a first sub-band 710-a, and a second CORESET 715-b may be in a second sub-band 710-b. The search space set 720 may include CCEs 725 associated with multiple CORESETs. For example, the search space set 720 may include the CCE 725-a of the first CORESET 715-a on the first sub-band 710-a, and the search space set 720 may include the CCE 725-b of the second CORESET 715-b on the second sub-band 710-b. For each AL (e.g., AL=L), the network entity 105 may determine L CCEs per CORESET separately. PDCCH candidates of the same AL may be explicitly linked.

The UE 115 may perform CCE or blind decode dropping. In some examples, if CCE or blind decoding dropping is performed, the PDCCH candidates of the search space set 720 may all be dropped if some needs to be dropped. For example, if the CCE 725-a is dropped, the CCE 725-b may also be dropped based on both the CCEs 725 being included in the search space set 720. In some examples, the CCEs or blind decodes may be dropped one sub-band 710 at a time based on ascending or descending index orders. For example, the UE 115 may drop the CCEs or blind decodes associated with the first sub-band 710-a based on an index associated with the first sub-band 710-a. In some examples, the UE 115 may perform PDCCH candidate level dropping, as described with reference to FIG. 6.

The FSI configuration may utilize FDM (e.g., TDM may be achieved via the search space set 720). In some examples, the UE 115 may include no additional buffering based on the FSI configuration. In some examples, the UE 115 may include additional buffering based on PDCCH candidate association across different monitoring occasions of the same search space set 720. The FSI configuration may include PDCCH repetition associated with a uniform distribution or a non-uniform distribution as described with reference to FIG. 6. Additionally, or alternatively, the FSI configuration may include blind decode counting as described with reference to FIG. 6.

FIG. 7B shows an example of a virtual cell 705 that supports PDCCH design for FSI in accordance with one or more aspects of the present disclosure. In some examples, virtual cell 705 may implement aspects of, or be implemented by aspects of, the wireless communications system 100, the wireless communications system 200, the TB scheduling configuration 300, the TB scheduling configuration 305, the control channel resource configuration 400, the CORESET configuration 500, the virtual cell 600, or the virtual cell 700. A virtual cell 705 (e.g., described with reference to FIG. 2) may represent communication resources associated with a UE 115 and a network entity 105. The network entity 105 and the UE 115 may be examples of a network entity 105 and a UE 115 as described with reference to FIGS. 1-7A. The virtual cell may include a first sub-band 710-c and a second sub-band 710-d. In some cases, the virtual cell may include additional sub-bands 710 (not shown). The first sub-band 710-c may include a first CORESET 715-c (e.g., core resource set), and the second sub-band 710-d may include a second CORESET 715-d.

A CORESET 715 may include one or more CCEs. REG bundles for a given CCE may be distributed across sub-bands 710. For example, the first CORESET 715-c may include a first REG bundle 730-a. The second CORESET 715-d may include a second REG bundle 730-b. A search space set 720 may support REG bundle interleaving. The search space set 720 may include the first REG bundle 730-a and the second REG bundle 730-b. An AL associated with the search space set 720 may be based on an AL associated with the REG bundles (e.g., AL=L).

FIG. 8 shows an example of a virtual cell 800 that supports PDCCH design for FSI in accordance with one or more aspects of the present disclosure. In some examples, virtual cell 800 may implement aspects of, or be implemented by aspects of, the wireless communications system 100, the wireless communications system 200, the TB scheduling configuration 300, the TB scheduling configuration 305, the control channel resource configuration 400, the CORESET configuration 500, the virtual cell 600, the virtual cell 700, or the virtual cell 705. For example, the virtual cell 800 may represent communication via a wireless communication link between a UE 115 and a network entity 105 which may be examples of corresponding devices described with reference to FIGS. 1-7B.

In some cases, the FSI configuration may include a wide-band CORESET 810 associated with multiple sub-bands 805 corresponding to one or more separate RB sets 815. In some examples, the FSI configuration may include a search space set associated with multiple RB sets 815 (e.g., a hashing function may be defined across the RB sets 815 or per RB set 815). In some examples, the FSI configuration may include a search space set associated with a single RB set 815 (e.g., a hashing function may be defined per RB set 815).

In some cases, the FSI configuration may include a CORESET 810 configured across multiple sub-bands 805. The CORESET 810 may include different disjoint portions (e.g., RB sets 815). Each RB set 815 may be fully contained in one sub-band 805. In some cases, multiple RB sets 815 may be in one sub-band 805. For example, a CORESET 810 may include a first RB set 815-a in a first sub-band 805-a and a second RB set 815-b in a second sub-band 805-b. Each RB set 815 may be associated with a different QCL source and follow a different TCI state.

In some examples, a single search space set may be associated with multiple RB sets (e.g., a hashing function may be defined across the RB sets 815 or be per RB set 815). For example, the single search space set may include the first RB set 815-a and the second RB set 815-b. If the hashing function is defined across RB sets, the FSI configuration may support a uniform distribution of CCEs across RB sets (e.g., the FSI may support joint rate matching (RM)). If the hashing function is defined per RB set 815, the FSI configuration may support PDCCH repetition across RB sets 815. The FSI configuration may support a non-uniform distribution of CCEs forming a PDCCH candidate of a given AL.

In some cases, the FSI configuration may include a search space set associated with a single RB set 815 (e.g., a hashing function may be per RB set 815). For example, the search space set may include the first RB set 815. The FSI configuration may support PDCCH repetition across RB sets 815. The FSI configuration may support a non-uniform distribution of CCEs forming a PDCCH candidate of a given AL.

Limiting a search space set to an RB set 815 reduces the overhead associated with the coexistence of UEs 115 with different PDCCH capabilities (e.g., the UEs 115 supporting the FSI configuration and the UEs 115 associated with lower capabilities). A search space sets belonging to a wide-band CORESET may be configured according to the techniques described herein (e.g., configurated with a search space set associated with multiple RB sets 815 or a search space set associated with a single RB set 815) and support PDCCH repetition for uniform or non-uniform distributions. In some cases, the uniform or non-uniform distribution may be based on DCI formats of different sizes.

For PDCCH repetition, CCE to PDCCH candidate mapping may be configured per RB set 815. The PDCCH candidate mapping configuration may be based on the configured PDCCH candidate linkage. The UE 115 may decode a PDCCH candidate of AL=n*L if each RB set 815 includes a PDCCH candidate of AL=L. For distributed PDCCH with uniform distribution, the FSI configuration may map REG bundle to CCE and CCE to PDCCH candidate. The REGs forming an REG bundle may all be within one PDCCH RB set 815. For non-uniform distributed PDCCH, the FSI configuration may define a linkage between a first PDCCH candidate of a first AL (e.g., AL=m) in a first RB set 815 (e.g., RB set i) and a second PDCCH candidate of a second AL (e.g., AL=n) in a second RB set 815 (e.g., RB set j) to form a third PDCCH candidate of a third AL (e.g., AL=m+n). The FSI configuration may be similar to the multiple CORESET design described with reference to FIGS. 6-7B.

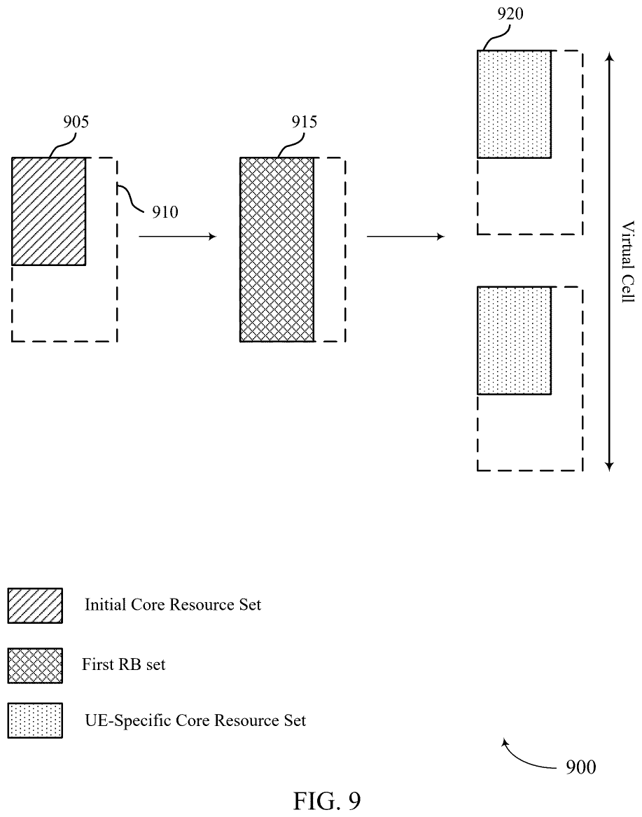

FIG. 9 shows an example of a communications timeline 900 that supports PDCCH design for FSI in accordance with one or more aspects of the present disclosure. In some examples, communications timeline 900 may implement aspects of, or be implemented by aspects of, the wireless communications system 100, the wireless communications system 200, the TB scheduling configuration 300, the TB scheduling configuration 305, the control channel resource configuration 400, the CORESET configuration 500, the virtual cell 600, the virtual cell 700, the virtual cell 705, or the virtual cell 800. For example, the communications timeline may show communication between a UE 115 and a network entity 105 which may be examples of corresponding devices described with reference to FIGS. 1-8.

The network entity 105 may configure PDCCH coverage for system information block type 1 915 (SIB1), initial access, or paging. In some cases, an initial CORESET 905 (e.g., CORESET0) may be signaled to the UE 115 via a master information block (MIB) or physical broadcast channel (PBCH). The initial CORESET 905 may be included on an anchor sub-band 910 (e.g., a PCell in carrier aggregation), which the UE 115 may camp (e.g., monitor). The MIB or PBCH may schedule an SIB1 915 on the anchor sub-band 910. The network entity 105 may configure (e.g., during RRC connected state) the virtual cell (e.g., virtual carrier). The virtual cell may include one or more UE-specific CORESETs 920 (e.g., multiple CORESETs, as described with reference to FIGS. 6-7B, or a single wide-band coreset as illustrated in FIG. 8).

The network entity 105 may configure the initial CORESET 905 (e.g., CORESET0 configuration where the UE 115 monitors for a SIB1 915 PDCCH) via an indication in MIB or PBCH indicating (e.g., pointing) to one or more tables. For example, the MIB or PBCH may include an index. The index may indicate a search space or PBCH block and CORESET multiplexing pattern, a quantity of RBs, a quantity of symbols, and an offset (e.g., RBs). To provide information about other CORESETs 920 (e.g., as described with reference to FIGS. 6-7B) or other portions of a wide-band CORESET 920 (e.g., as described with reference to FIG. 8), such tables should be expanded. Additionally, or alternatively, the MIB or PBCH may provide additional information such as pointers to a different set of rows.

In some cases, a QCL source for one or more CORESETs or a portion of a wide-band CORESET may be in a different sub-band. The QCL source may be based on a SSB selected by the UE 115 on the anchor sub-band 910 (e.g., in case the sub-bands are intra-band and contiguous).

In some cases, the network entity 105 may configure a PDCCH configuration (e.g., PDCCH-ConfigCommon). The PDCCH configuration may configure cell specific PDCCH parameters provided in SIB. In some examples, a common control resource set (e.g., commonControlResourceSet) may be contained within the allocation of the initial CORESET 905 (e.g., CORESET0). In some examples, the common control resource set may be configured by including more information about the other CORESETs or portions of wide-band CORESET. For example, the common control resource set may indicate one or more CORESETs (e.g., as described with reference to FIGS. 6-7B) or a wide-band CORESET (e.g., as described with reference to FIG. 8).

All the functionalities provided by the one or more CORESETs indicated via the common control resource set (e.g., paging, random access, permanent equipment identifier (PEI)) may benefit based on the techniques described herein (e.g., increased frequency diversity). In some cases, the common control resource set (e.g., commonControlResourceSet) may be defined or configured for different type of UEs 115 (e.g., UEs 115 associated with different PDCCH monitoring capabilities).

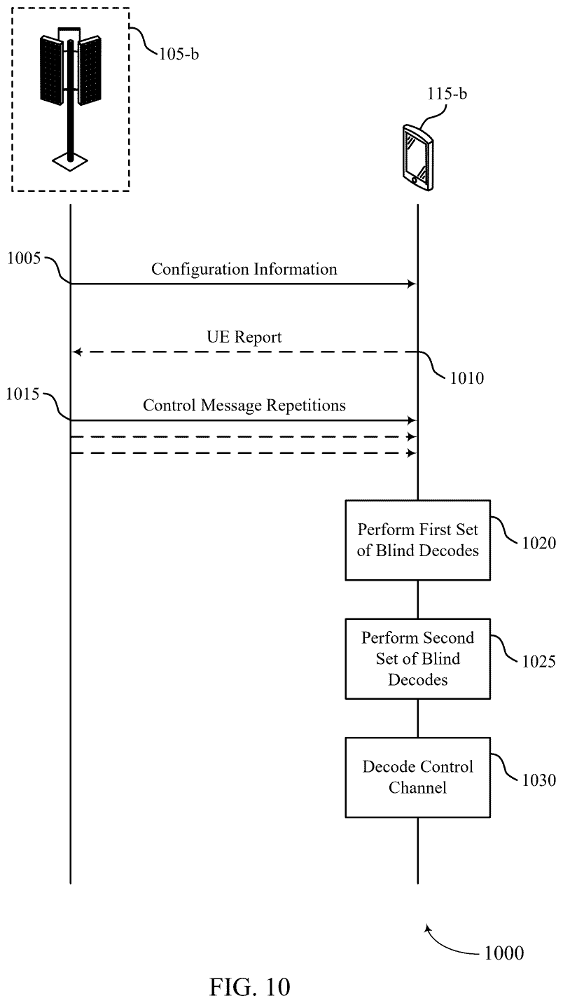

FIG. 10 shows an example of a process flow 1000 that supports PDCCH design for FSI in accordance with one or more aspects of the present disclosure. In some examples, process flow 1000 may implement aspects of, or be implemented by aspects of, the wireless communications system 100, the wireless communications system 200, the TB scheduling configuration 300, the TB scheduling configuration 305, the control channel resource configuration 400, the CORESET configuration 500, the virtual cell 600, the virtual cell 700, the virtual cell 705, the virtual cell 800, or the communications timeline 900. For example, the process flow 1000 may include a UE 115-b and a network entity 105-b which may be examples of corresponding devices described with reference to FIGS. 1-9.

At 1005, the UE 115-b may receive configuration information (e.g., an FSI configuration) that indicates a set of monitoring occasions in multiple sub-bands for monitoring of a set of PDCCH candidates for reception of a control channel or repetitions of the control channel. The set of PDCCH candidates may be distributed across the multiple sub-bands.

At 1010, the UE 115-b may transmit a UE report indicating a quantity of blind decodes based on a quantity of associated search space sets indicated by the configuration information.
At 1015, the network entity 105-b may transmit one or more control message repetitions. The network entity 105-b may transmit, in accordance with the configuration information, a first control message during a first monitoring occasion of the set of monitoring occasions. The first monitoring occasion may be associated with a first search space of a first PDCCH CORESET in a first sub-band of the multiple sub-bands. The network entity 105 may transmit, in accordance with the configuration information, a second control message during a second monitoring occasion of the set of monitoring occasions. The second monitoring occasion may be associated with a second search space of a second PDCCH CORESET in a second sub-band of the multiple sub-bands. The configuration information may associate the first search space with the second search space (e.g., the first search space set may be linked to the second search space set).

At 1020, the UE 115-b may perform, in accordance with the configuration information, a first set of blind decodes during a first monitoring occasion of the set of monitoring occasions. The first monitoring occasion may be associated with a first search space set of a first PDCCH CORESET in a first sub-band of the multiple sub-bands.

At 1025, the UE 115-b may perform, in accordance with the configuration information, a second set of blind decodes during a second monitoring occasion of the set of monitoring occasions. The second monitoring occasion may be associated with a second search space set of a second PDCCH CORESET in a second sub-band of the multiple sub-bands. The configuration information may associate the first search space set with the second search space set (e.g., the first search space set may be linked to the second search space set).

In some cases, the first PDCCH CORESET and the second PDCCH CORESET may be different, and the first search space set and the second search space set may be different, as described with reference to FIG. 6. The first search space set and the second search space set may be associated via a mapping between search space sets of different sub-bands. The mapping may be on a per group of PDCCH candidates basis. The first CORESET configuration associated with the first PDCCH CORESET is independent of a second PDCCH CORESET configuration associated with the second PDCCH CORESET. One or more parameters of a first coreset configuration associated with the first PDCCH CORESET may be the same as a corresponding one or more parameters of a second PDCCH CORESET configuration associated with the second PDCCH CORESET. The one or more parameters may include at least one of an AL, a payload, a quantity of coded bits, or a search space set type.

In some cases, the set of PDCCH candidates that may be distributed across the multiple sub-bands may be a part of a virtual carrier. The virtual carrier may be a primary cell when aggregated with other cells. In some examples, the UE 115-b may refrain from monitoring a third search space set based on a dropping rule. The dropping rule may indicate that search space sets are dropped from monitoring based on an ordering of sub-band indices and search space set indices. In some examples, the UE 115-b may refrain from monitoring a third search space set based on a dropping rule. The dropping rule may indicate that search space sets are dropped from monitoring based on an ordering of candidate indices.

In some cases, an effective AL corresponding to the set of PDCCH candidates may be based on a quantity of sub-bands associated with the set of PDCCH candidates. In some examples, the effective AL may be based on a uniform distribution of CCE of a PDCCH candidate having a first AL within a search space set associated with the set of PDCCH candidates across the quantity of sub-bands. In some examples, the effective AL may be based on a non-uniform distribution of CCEs of a PDCCH candidate having a first AL within a search space set associated with the set of PDCCH candidates across the quantity of sub-bands.

In some cases, the first PDCCH CORESET and the second PDCCH CORESET may be different, and the first search space set and the second search space set may be portions of a same search space set, as described with reference to FIG. 7. The first search space set may include a quantity of control channel resources (e.g., CCEs) on the first PDCCH CORESET and the second search space set may include the quantity of control channel resources on the second PDCCH CORESET. A first PDCCH candidate associated with the first search space set and a second PDCCH candidate associated with the second search space set may have a same AL, and the first PDCCH candidate and the second PDCCH candidate may be of the set of PDCCH candidates.

In some cases, the set of PDCCH candidates that may be distributed across the multiple sub-bands may be part of a virtual carrier. The virtual carrier may be a primary cell when aggregated with other cells. In some examples, the UE 115-b may refrain from monitoring the first search space set based on a dropping rule. The dropping rule may indicate that search space sets are dropped from monitoring based on an ordering of sub-band indices and search space set indices. In some examples, the UE 115-b may refrain from monitoring the first search space set based on a dropping rule. The dropping rule may indicate that search space sets are dropped from monitoring based on an ordering of candidate indices.

In some cases, an effective AL corresponding to the set of PDCCH candidates may be based on a quantity of control channel resources associated with the set of PDCCH candidates and a same AL. In some examples, the effective AL may be based on a uniform distribution of CCEs of a PDCCH candidate having a first AL within the same search space set associated with the set of PDCCH candidates across the quantity of sub-bands. In some examples, the effective AL may be based on a non-uniform distribution of CCEs of a PDCCH candidate having a first AL within the same search space set associated with the set of PDCCH candidates across the quantity of sub-bands.

In some cases, the first PDCCH CORESET and the second PDCCH CORESET may be portions of a same PDCCH CORESET, and the same PDCCH CORESET may include includes a first RB set in the first sub-band and a second RB set in the second sub-band, as described with reference to FIG. 8. The first RB set may be associated with a first QCL source and a first TCI state, the second RB set may be associated with a second QCL source and a second TCI state. The first QCL source may be different than the second QCL, and the first TCI state may be different than the second TCI state.

In some cases, the first search space set and the second search space set are portions of a same search space set. The first search space set may be associated with the first RB set, and the second search space set may be associated with the second RB set. In some examples, The same search space set may be associated with a hashing function for the first RB set and the second RB set. The first RB set and the second RB set may include a same quantity of control channel resources. In some examples, The same search space set may be associated with a first hashing function for the first RB set and a second hashing function for the second RB set.

In some cases, the first search space set and the second search space set may be different. The first search space set may be associated with the first RB set and the second search space set may be associated with the second RB set. The first search space set is associated with a first hashing function for the first RB set and the second search space set is associated with a second hashing function for the second RB set.

In some cases, CCEs of a PDCCH candidate having a first AL associated within a search space set of the same PDCCH CORESET may be uniformly distributed across a quantity of sub-bands associated with the same PDCCH CORESET. Each REG bundle of the same PDCCH CORESET may be included within a respective sub-band.

In some cases, CCEs of a PDCCH candidate having a respective AL within a search space set of the same PDCCH CORESET may be non-uniformly distributed across a quantity of sub-bands associated with the same PDCCH CORESET. A first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate. In some cases, an effective AL corresponding to the set of PDCCH candidates may be based on a quantity of RBs associated with the set of PDCCH candidates.

At 1030, the UE 115-b may decode the control channel or the repetitions of the control channel based on the first set of blind decodes and the second set of blind decodes.

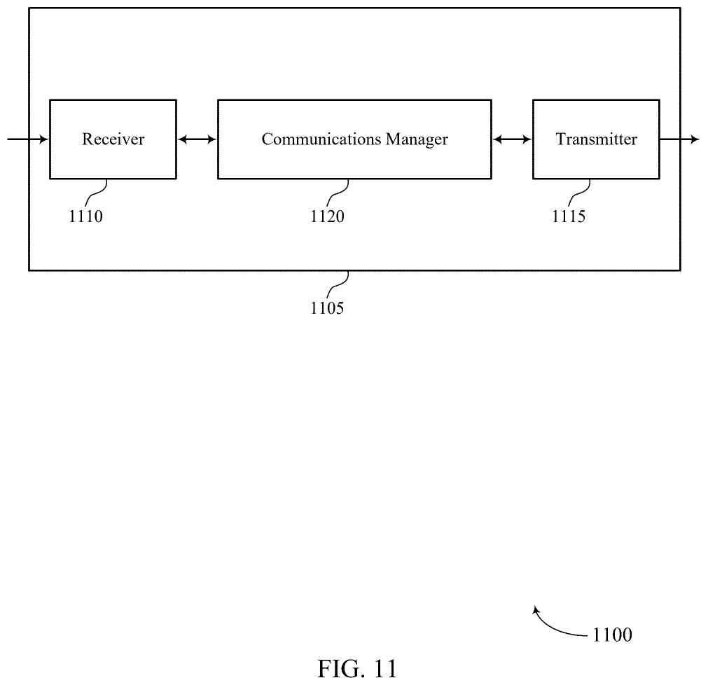

FIG. 11 shows a block diagram 1100 of a device 1105 that supports PDCCH design for FSI in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to PDCCH design for FSI). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to PDCCH design for FSI). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of PDCCH design for FSI as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The communications manager 1120 is capable of, configured to, or operable to support a means for performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. The communications manager 1120 is capable of, configured to, or operable to support a means for performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The communications manager 1120 is capable of, configured to, or operable to support a means for decoding the control channel or the repetitions of the control channel based on the first set of blind decodes and the second set of blind decodes.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources and the like.

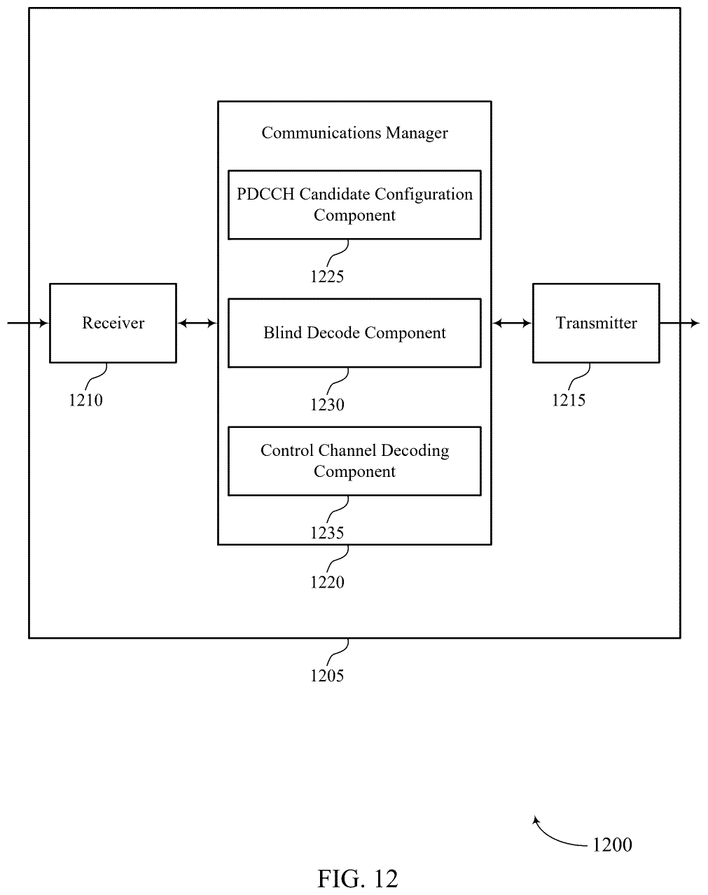

FIG. 12 shows a block diagram 1200 of a device 1205 that supports PDCCH design for FSI in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to PDCCH design for FSI). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to PDCCH design for FSI). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of PDCCH design for FSI as described herein. For example, the communications manager 1220 may include a PDCCH candidate configuration component 1225, a blind decode component 1230, a control channel decoding component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The PDCCH candidate configuration component 1225 is capable of, configured to, or operable to support a means for receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The blind decode component 1230 is capable of, configured to, or operable to support a means for performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. The blind decode component 1230 is capable of, configured to, or operable to support a means for performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The control channel decoding component 1235 is capable of, configured to, or operable to support a means for decoding the control channel or the repetitions of the control channel based on the first set of blind decodes and the second set of blind decodes.

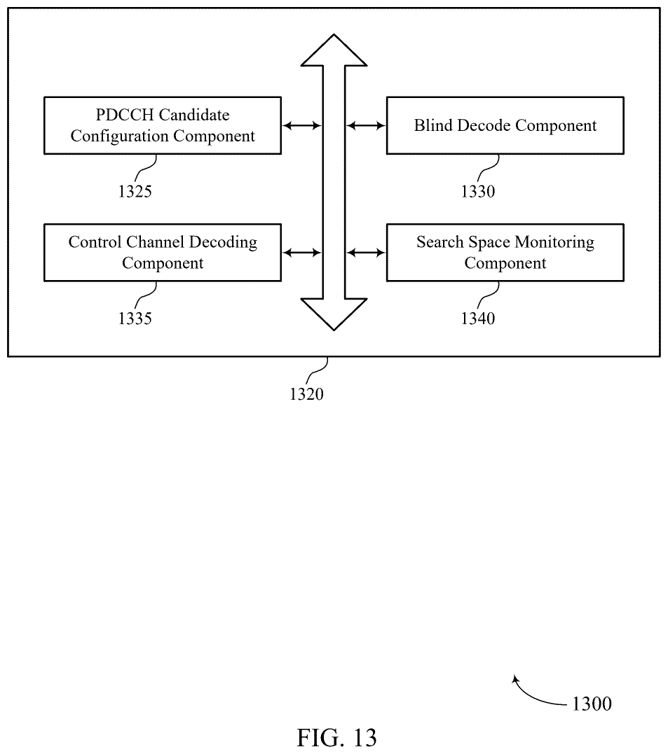

FIG. 13 shows a block diagram 1300 of a communications manager 1320 that supports PDCCH design for FSI in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of PDCCH design for FSI as described herein. For example, the communications manager 1320 may include a PDCCH candidate configuration component 1325, a blind decode component 1330, a control channel decoding component 1335, a search space monitoring component 1340, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The PDCCH candidate configuration component 1325 is capable of, configured to, or operable to support a means for receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The blind decode component 1330 is capable of, configured to, or operable to support a means for performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. In some examples, the blind decode component 1330 is capable of, configured to, or operable to support a means for performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The control channel decoding component 1335 is capable of, configured to, or operable to support a means for decoding the control channel or the repetitions of the control channel based on the first set of blind decodes and the second set of blind decodes.

In some examples, the first PDCCH CORESET and the second PDCCH CORESET are different. In some examples, the first search space set and the second search space set are different.

In some examples, the first search space set and the second search space set are associated via a mapping between search space sets of different sub-bands. In some examples, the mapping is on a per group of PDCCH candidates basis.

In some examples, a first coreset configuration associated with the first PDCCH CORESET is independent of a second PDCCH CORESET configuration associated with the second PDCCH CORESET.

In some examples, one or more parameters of a first coreset configuration associated with the first PDCCH CORESET are the same as a corresponding one or more parameters of a second PDCCH CORESET configuration associated with the second PDCCH CORESET. In some examples, the one or more parameters include at least one of an AL, a payload, a quantity of coded bits, or a search space set type.

In some examples, the set of multiple PDCCH candidates that are distributed across the multiple sub-bands are part of a virtual carrier, and the search space monitoring component 1340 is capable of, configured to, or operable to support a means for refraining from monitoring a third search space set based on a dropping rule, where the dropping rule indicates that search space sets are dropped from monitoring based on an ordering of sub-band indices and search space set indices.

In some examples, the set of multiple PDCCH candidates that are distributed across the multiple sub-bands are part of a virtual carrier, and the search space monitoring component 1340 is capable of, configured to, or operable to support a means for refraining from monitoring a third search space set based on a dropping rule, where the dropping rule indicates that search space sets are dropped from monitoring based on an ordering of candidate indices.

In some examples, the blind decode component 1330 is capable of, configured to, or operable to support a means for transmitting a UE report indicating a quantity of blind decodes based on a quantity of associated search space sets indicated by the configuration information.

In some examples, an effective AL corresponding to the set of multiple PDCCH candidates is based on a quantity of sub-bands associated with the set of multiple PDCCH candidates.

In some examples, the effective AL is based on a uniform distribution of CCEs of a PDCCH candidate having a first AL within a search space set associated with the set of multiple PDCCH candidates across the quantity of sub-bands.

In some examples, the effective AL is based on a non-uniform distribution of CCEs of a PDCCH candidate having a first AL within a search space set associated with the set of multiple PDCCH candidates across the quantity of sub-bands.

In some examples, the first PDCCH CORESET and the second PDCCH CORESET are different. In some examples, the first search space set and the second search space set are portions of a same search space set.

In some examples, the first search space set includes a quantity of control channel resources on the first PDCCH CORESET and the second search space set includes the quantity of control channel resources on the second PDCCH CORESET. In some examples, a first PDCCH candidate associated with the first search space set and a second PDCCH candidate associated with the second search space set have a same AL, the first PDCCH candidate and the second PDCCH candidate being of the set of multiple PDCCH candidates.

In some examples, the set of multiple PDCCH candidates that are distributed across the multiple sub-bands are part of a virtual carrier, and the search space monitoring component 1340 is capable of, configured to, or operable to support a means for refraining from monitoring the first search space set based on a dropping rule, where the dropping rule indicates that search space sets are dropped from monitoring based on an ordering of sub-band indices and search space set indices.

In some examples, the set of multiple PDCCH candidates that are distributed across the multiple sub-bands are part of a virtual carrier, and the search space monitoring component 1340 is capable of, configured to, or operable to support a means for refraining from monitoring the first search space set based on a dropping rule, where the dropping rule indicates that search space sets are dropped from monitoring based on an ordering of candidate indices.

In some examples, an effective AL corresponding to the set of multiple PDCCH candidates is based on a quantity of control channel resources associated with the set of multiple PDCCH candidates and a same AL.

In some examples, the effective AL is based on a uniform distribution of CCEs of a PDCCH candidate having a first AL within the same search space set associated with the set of multiple PDCCH candidates across the quantity of sub-bands.

In some examples, the effective AL is based on a non-uniform distribution of CCEs of a PDCCH candidate having a first AL within the same search space set associated with the set of multiple PDCCH candidates across the quantity of sub-bands.

In some examples, the blind decode component 1330 is capable of, configured to, or operable to support a means for transmitting a UE report indicating a quantity of blind decodes based on a quantity of associated search space sets indicated by the configuration information.

In some examples, the first PDCCH CORESET and the second PDCCH CORESET are portions of a same PDCCH CORESET. In some examples, the same PDCCH CORESET includes a first RB set in the first sub-band and a second RB set in the second sub-band.

In some examples, the first RB set is associated with a first quasi co-located source and a first transmission configuration indicator state, the second RB set is associated with a second quasi co-located source and a second transmission configuration indicator state, the first quasi co-located source is different than the second quasi co-located source, and the first transmission configuration indicator state is different than the second transmission configuration indicator state.

In some examples, the first search space set and the second search space set are portions of a same search space set. In some examples, the first search space set is associated with the first RB set and the second search space set is associated with the second RB set.

In some examples, the same search space set is associated with a hashing function for the first RB set and the second RB set. In some examples, the first RB set and the second RB set include a same quantity of control channel resources.

In some examples, the same search space set is associated with a first hashing function for the first RB set and a second hashing function for the second RB set.

In some examples, the first search space set and the second search space set are different. In some examples, the first search space set is associated with the first RB set and the second search space set is associated with the second RB set.

In some examples, the first search space set is associated with a first hashing function for the first RB set and the second search space set is associated with a second hashing function for the second RB set.

In some examples, CCEs of a PDCCH candidate having a first AL associated within a search space set of the same PDCCH CORESET are uniformly distributed across a quantity of sub-bands associated with the same PDCCH CORESET.

In some examples, each resource element group bundle of the same PDCCH CORESET is included within a respective sub-band.

In some examples, CCEs of a PDCCH candidate having a respective AL within a search space set of the same PDCCH CORESET are non-uniformly distributed across a quantity of sub-bands associated with the same PDCCH CORESET.

In some examples, a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

In some examples, an effective AL corresponding to the set of multiple PDCCH candidates is based on a quantity of RBs associated with the set of multiple PDCCH candidates.

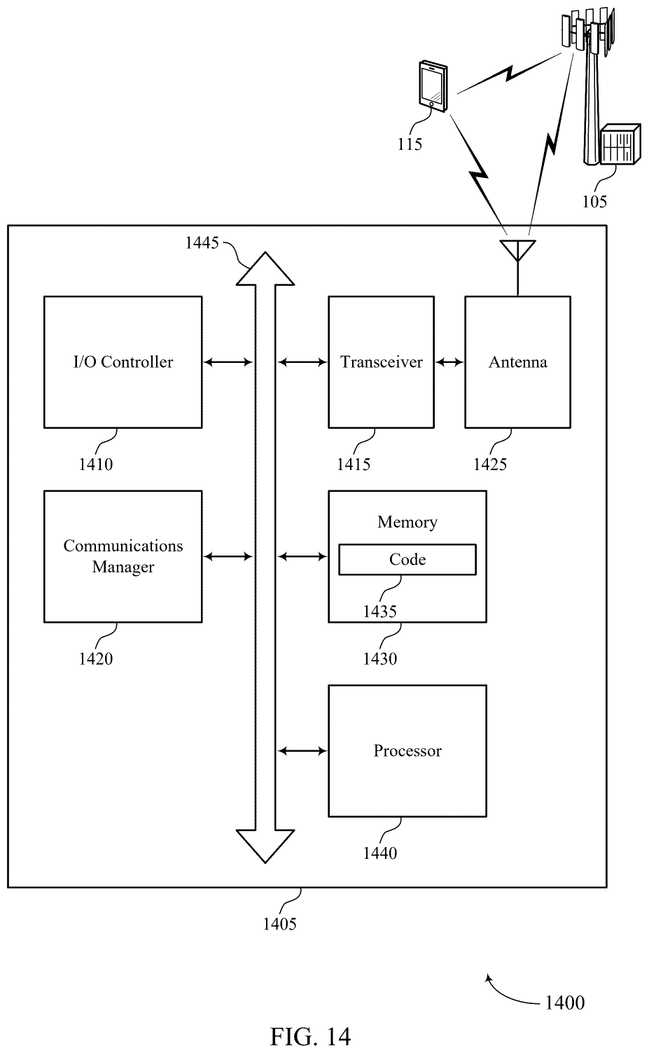

FIG. 14 shows a diagram of a system 1400 including a device 1405 that supports PDCCH design for FSI in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting PDCCH design for FSI). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with examples as disclosed herein. For example, the communications manager 1420 is capable of, configured to, or operable to support a means for receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The communications manager 1420 is capable of, configured to, or operable to support a means for performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. The communications manager 1420 is capable of, configured to, or operable to support a means for performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The communications manager 1420 is capable of, configured to, or operable to support a means for decoding the control channel or the repetitions of the control channel based on the first set of blind decodes and the second set of blind decodes.

By including or configuring the communications manager 1420 in accordance with examples as described herein, the device 1405 may support techniques for improved communication reliability, reduced latency, more efficient utilization of communication resources, improved coordination between devices, and the like.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of PDCCH design for FSI as described herein, or the at least one processor 1440 and the at least one memory 1430 may be otherwise configured to, individually or collectively, perform or support such operations.

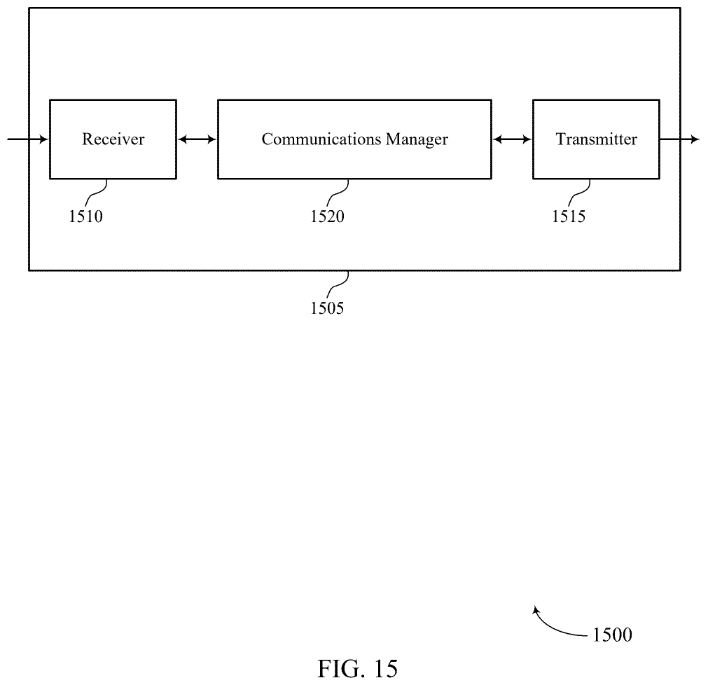

FIG. 15 shows a block diagram 1500 of a device 1505 that supports PDCCH design for FSI in accordance with one or more aspects of the present disclosure. The device 1505 may be an example of aspects of a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of PDCCH design for FSI as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands. The communications manager 1520 is capable of, configured to, or operable to support a means for transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands. The communications manager 1520 is capable of, configured to, or operable to support a means for transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for more efficient utilization of communication resources.

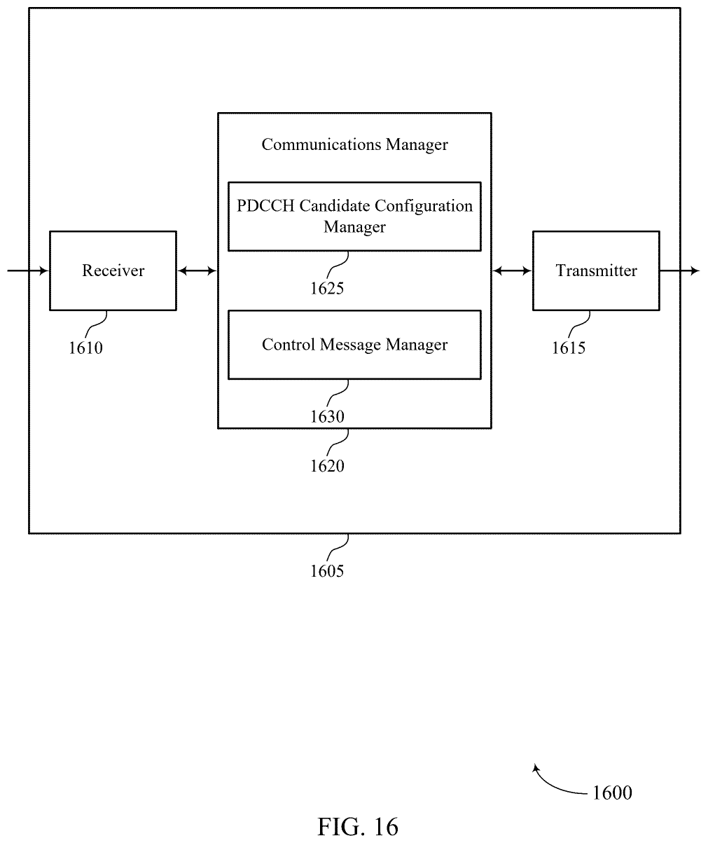

FIG. 16 shows a block diagram 1600 of a device 1605 that supports PDCCH design for FSI in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of PDCCH design for FSI as described herein. For example, the communications manager 1620 may include a PDCCH candidate configuration manager 1625 a control message manager 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The PDCCH candidate configuration manager 1625 is capable of, configured to, or operable to support a means for transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands. The control message manager 1630 is capable of, configured to, or operable to support a means for transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands. The control message manager 1630 is capable of, configured to, or operable to support a means for transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

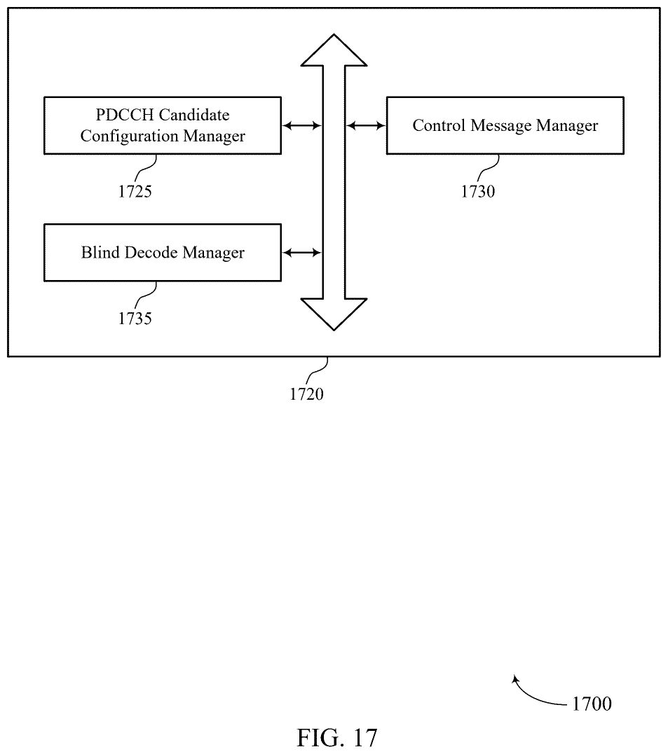

FIG. 17 shows a block diagram 1700 of a communications manager 1720 that supports PDCCH design for FSI in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of PDCCH design for FSI as described herein. For example, the communications manager 1720 may include a PDCCH candidate configuration manager 1725, a control message manager 1730, a blind decode manager 1735, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications in accordance with examples as disclosed herein. The PDCCH candidate configuration manager 1725 is capable of, configured to, or operable to support a means for transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands. The control message manager 1730 is capable of, configured to, or operable to support a means for transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands. In some examples, the control message manager 1730 is capable of, configured to, or operable to support a means for transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

In some examples, the first PDCCH CORESET and the second PDCCH CORESET are different. In some examples, the first search space set and the second search space set are different.

In some examples, the first search space set and the second search space set are associated via a mapping between search space sets of different sub-bands. In some examples, the mapping is on a per group of PDCCH candidates basis.

In some examples, a first coreset configuration associated with the first PDCCH CORESET is independent of a second PDCCH CORESET configuration associated with the second PDCCH CORESET.

In some examples, one or more parameters of a first coreset configuration associated with the first PDCCH CORESET are the same as a corresponding one or more parameters of a second PDCCH CORESET configuration associated with the second PDCCH CORESET. In some examples, the one or more parameters include at least one of an AL, a payload, a quantity of coded bits, or a search space set type.

In some examples, the blind decode manager 1735 is capable of, configured to, or operable to support a means for receiving a UE report indicating a quantity of blind decodes based on a quantity of associated search space sets indicated by the configuration information.

In some examples, an effective AL corresponding to the set of multiple PDCCH candidates is based on a quantity of sub-bands associated with the set of multiple PDCCH candidates.

In some examples, the effective AL is based on a uniform distribution of CCEs of a PDCCH candidate having a first AL within a search space set associated with the set of multiple PDCCH candidates across the quantity of sub-bands.

In some examples, the effective AL is based on a non-uniform distribution of CCEs of a PDCCH candidate having a first AL within a search space set associated with the set of multiple PDCCH candidates across the quantity of sub-bands.

In some examples, the first PDCCH CORESET and the second PDCCH CORESET are different. In some examples, the first search space set and the second search space set are portions of a same search space set.

In some examples, the first search space set includes a quantity of control channel resources on the first PDCCH CORESET and the second search space set includes the quantity of control channel resources on the second PDCCH CORESET. In some examples, a first PDCCH candidate associated with the first search space set and a second PDCCH candidate associated with the second search space set have a same AL, the first PDCCH candidate and the second PDCCH candidate being of the set of multiple PDCCH candidates.

In some examples, an effective AL corresponding to the set of multiple PDCCH candidates is based on a quantity of control channel resources associated with the set of multiple PDCCH candidates and a same AL.

In some examples, the effective AL is based on a uniform distribution of CCEs of a PDCCH candidate having a first AL within the same search space set associated with the set of multiple PDCCH candidates across the quantity of sub-bands.

In some examples, the effective AL is based on a non-uniform distribution of CCEs of a PDCCH candidate having a first AL within the same search space set associated with the set of multiple PDCCH candidates across the quantity of sub-bands.

In some examples, the blind decode manager 1735 is capable of, configured to, or operable to support a means for receiving a UE report indicating a quantity of blind decodes based on a quantity of associated search space sets indicated by the configuration information.

In some examples, the first PDCCH CORESET and the second PDCCH CORESET are portions of a same PDCCH CORESET. In some examples, the same PDCCH CORESET includes a first RB set in the first sub-band and a second RB set in the second sub-band.

In some examples, the first RB set is associated with a first quasi co-located source and a first transmission configuration indicator state, the second RB set is associated with a second quasi co-located source and a second transmission configuration indicator state, the first quasi co-located source is different than the second quasi co-located source, and the first transmission configuration indicator state is different than the second transmission configuration indicator state.

In some examples, the first search space set and the second search space set are portions of a same search space set. In some examples, the first search space set is associated with the first RB set and the second search space set is associated with the second RB set.

In some examples, the same search space set is associated with a hashing function for the first RB set and the second RB set. In some examples, the first RB set and the second RB set include a same quantity of control channel resources.

In some examples, the same search space set is associated with a first hashing function for the first RB set and a second hashing function for the second RB set.

In some examples, the first search space set and the second search space set are different. In some examples, the first search space set is associated with the first RB set and the second search space set is associated with the second RB set.

In some examples, the first search space set is associated with a first hashing function for the first RB set and the second search space set is associated with a second hashing function for the second RB set.

In some examples, CCEs of a PDCCH candidate having a first AL associated within a search space set of the same PDCCH CORESET are uniformly distributed across a quantity of sub-bands associated with the same PDCCH CORESET.

In some examples, each resource element group bundle of the same PDCCH CORESET is included within a respective sub-band.

In some examples, CCEs of a PDCCH candidate having a respective AL within a search space set of the same PDCCH CORESET are non-uniformly distributed across a quantity of sub-bands associated with the same PDCCH CORESET.

In some examples, a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

In some examples, an effective AL corresponding to the set of multiple PDCCH candidates is based on a quantity of RBs associated with the set of multiple PDCCH candidates.

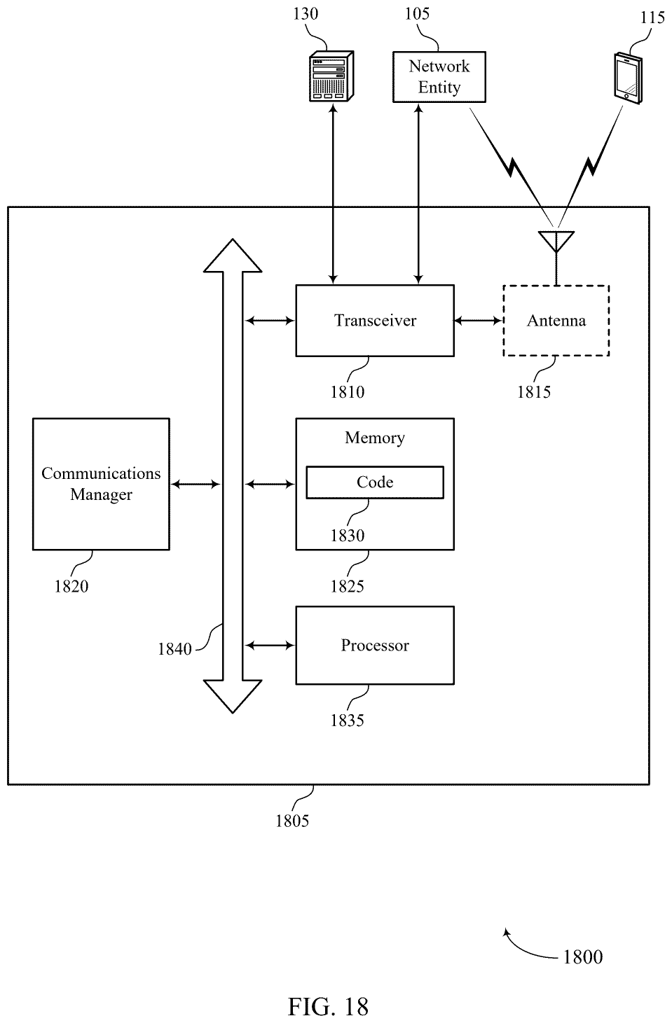

FIG. 18 shows a diagram of a system 1800 including a device 1805 that supports PDCCH design for FSI in accordance with one or more aspects of the present disclosure. The device 1805 may be an example of or include components of a device 1505, a device 1605, or a network entity 105 as described herein. The device 1805 may communicate with other network devices or network equipment such as one or more of the network entities 105, UEs 115, or any combination thereof. The communications may include communications over one or more wired interfaces, over one or more wireless interfaces, or any combination thereof. The device 1805 may include components that support outputting and obtaining communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting PDCCH design for FSI). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands. The communications manager 1820 is capable of, configured to, or operable to support a means for transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands. The communications manager 1820 is capable of, configured to, or operable to support a means for transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space.

By including or configuring the communications manager 1820 in accordance with examples as described herein, the device 1805 may support techniques for improved communication reliability, reduced latency, more efficient utilization of communication resources, improved coordination between devices, and the like.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of PDCCH design for FSI as described herein, or the at least one processor 1835 and the at least one memory 1825 may be otherwise configured to, individually or collectively, perform or support such operations.

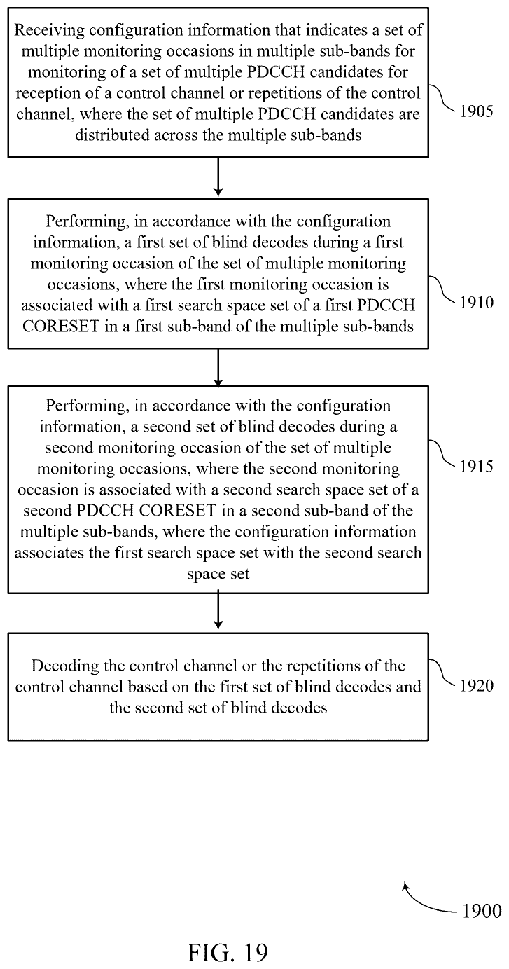

FIG. 19 shows a flowchart illustrating a method 1900 that supports PDCCH design for FSI in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The operations of 1905 may be performed in accordance with examples as disclosed herein. In some examples, aspects of the operations of 1905 may be performed by a PDCCH candidate configuration component 1325 as described with reference to FIG. 13.

At 1910, the method may include performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. The operations of 1910 may be performed in accordance with examples as disclosed herein. In some examples, aspects of the operations of 1910 may be performed by a blind decode component 1330 as described with reference to FIG. 13.

At 1915, the method may include performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The operations of 1915 may be performed in accordance with examples as disclosed herein. In some examples, aspects of the operations of 1915 may be performed by a blind decode component 1330 as described with reference to FIG. 13.

At 1920, the method may include decoding the control channel or the repetitions of the control channel based on the first set of blind decodes and the second set of blind decodes. The operations of 1920 may be performed in accordance with examples as disclosed herein. In some examples, aspects of the operations of 1920 may be performed by a control channel decoding component 1335 as described with reference to FIG. 13.

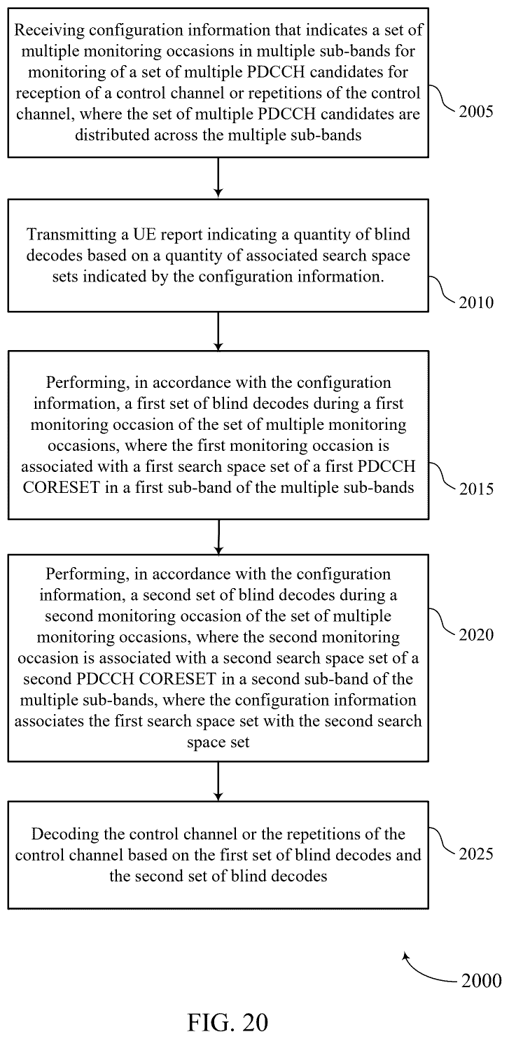

FIG. 20 shows a flowchart illustrating a method 2000 that supports PDCCH design for FSI in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2005, the method may include receiving configuration information that indicates a set of multiple monitoring occasions in multiple sub-bands for monitoring of a set of multiple PDCCH candidates for reception of a control channel or repetitions of the control channel, where the set of multiple PDCCH candidates are distributed across the multiple sub-bands. The operations of 2005 may be performed in accordance with examples as disclosed herein. In some examples, aspects of the operations of 2005 may be performed by a PDCCH candidate configuration component 1325 as described with reference to FIG. 13.

At 2010, the method may include transmitting a UE report indicating a quantity of blind decodes based on a quantity of associated search space sets indicated by the configuration information. The operations of 201 may be performed in accordance with examples as disclosed herein. In some examples, aspects of the operations of 2010 may be performed by a PDCCH candidate configuration component 1325 as described with reference to FIG. 13.

At 2015, the method may include performing, in accordance with the configuration information, a first set of blind decodes during a first monitoring occasion of the set of multiple monitoring occasions, where the first monitoring occasion is associated with a first search space set of a first PDCCH CORESET in a first sub-band of the multiple sub-bands. The operations of 2015 may be performed in accordance with examples as disclosed herein. In some examples, aspects of the operations of 2015 may be performed by a blind decode component 1330 as described with reference to FIG. 13.

At 2020, the method may include performing, in accordance with the configuration information, a second set of blind decodes during a second monitoring occasion of the set of multiple monitoring occasions, where the second monitoring occasion is associated with a second search space set of a second PDCCH CORESET in a second sub-band of the multiple sub-bands, where the configuration information associates the first search space set with the second search space set. The operations of 2020 may be performed in accordance with examples as disclosed herein. In some examples, aspects of the operations of 2020 may be performed by a blind decode component 1330 as described with reference to FIG. 13.

At 2025, the method may include decoding the control channel or the repetitions of the control channel based on the first set of blind decodes and the second set of blind decodes. The operations of 2025 may be performed in accordance with examples as disclosed herein. In some examples, aspects of the operations of 2025 may be performed by a control channel decoding component 1335 as described with reference to FIG. 13.

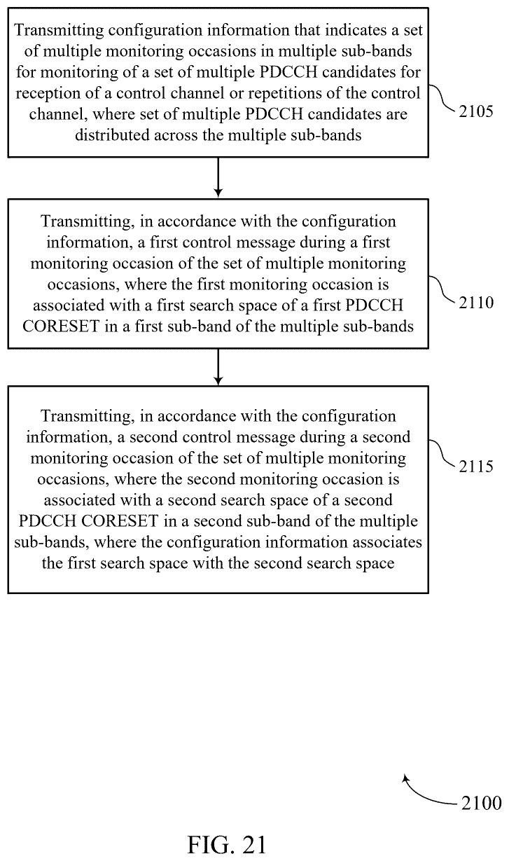

FIG. 21 shows a flowchart illustrating a method 2100 that supports PDCCH design for FSI in accordance with one or more aspects of the present disclosure. The operations of the method 2100 may be implemented by a network entity or its components as described herein. For example, the operations of the method 2100 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2105, the method may include transmitting configuration information that indicates a set of multiple monitoring occasions in multiple sub-bands for monitoring of a set of multiple PDCCH candidates for reception of a control channel or repetitions of the control channel, where set of multiple PDCCH candidates are distributed across the multiple sub-bands. The operations of 2105 may be performed in accordance with examples as disclosed herein. In some examples, aspects of the operations of 2105 may be performed by a PDCCH candidate configuration manager 1725 as described with reference to FIG. 17.

At 2110, the method may include transmitting, in accordance with the configuration information, a first control message during a first monitoring occasion of the set of multiple monitoring occasions, where the first monitoring occasion is associated with a first search space of a first PDCCH CORESET in a first sub-band of the multiple sub-bands. The operations of 2110 may be performed in accordance with examples as disclosed herein. In some examples, aspects of the operations of 2110 may be performed by a control message manager 1730 as described with reference to FIG. 17.

At 2115, the method may include transmitting, in accordance with the configuration information, a second control message during a second monitoring occasion of the set of multiple monitoring occasions, where the second monitoring occasion is associated with a second search space of a second PDCCH CORESET in a second sub-band of the multiple sub-bands, where the configuration information associates the first search space with the second search space. The operations of 2115 may be performed in accordance with examples as disclosed herein. In some examples, aspects of the operations of 2115 may be performed by a control message manager 1730 as described with reference to FIG. 17.

The following provides an overview of aspects of the present disclosure:

Aspect 1: A method for wireless communications at a UE, comprising: receiving configuration information that indicates a plurality of monitoring occasions in multiple sub-bands for monitoring of a plurality of PDCCH candidates for reception of a control channel or repetitions of the control channel, wherein the plurality of PDCCH candidates are distributed across the multiple sub-bands; performing, in accordance with the configuration information, a first set of blind decodes during a first monitoring occasion of the plurality of monitoring occasions, wherein the first monitoring occasion is associated with a first search space set of a first PDCCH CORESET in a first sub-band of the multiple sub-bands; performing, in accordance with the configuration information, a second set of blind decodes during a second monitoring occasion of the plurality of monitoring occasions, wherein the second monitoring occasion is associated with a second search space set of a second PDCCH CORESET in a second sub-band of the multiple sub-bands, wherein the configuration information associates the first search space set with the second search space set; and decoding the control channel or the repetitions of the control channel based at least in part on the first set of blind decodes and the second set of blind decodes.

Aspect 2: The method of aspect 1, wherein the first PDCCH CORESET and the second PDCCH CORESET are different, and the first search space set and the second search space set are different.

Aspect 3: The method of aspect 2, wherein the first search space set and the second search space set are associated via a mapping between search space sets of different sub-bands, and the mapping is on a per group of PDCCH candidates basis.

Aspect 4: The method of any of aspects 2 through 3, wherein a first coreset configuration associated with the first PDCCH CORESET is independent of a second PDCCH CORESET configuration associated with the second PDCCH CORESET.

Aspect 5: The method of any of aspects 2 through 4, wherein one or more parameters of a first coreset configuration associated with the first PDCCH CORESET are the same as a corresponding one or more parameters of a second PDCCH CORESET configuration associated with the second PDCCH CORESET, the one or more parameters include at least one of an AL, a payload, a quantity of coded bits, or a search space set type.

Aspect 6: The method of any of aspects 2 through 5, wherein the plurality of PDCCH candidates that are distributed across the multiple sub-bands are part of a virtual carrier, wherein the virtual carrier is a primary cell when aggregated with other cells, and wherein the method further comprises: refraining from monitoring a third search space set based at least in part on a dropping rule, wherein the dropping rule indicates that search space sets are dropped from monitoring based on an ordering of sub-band indices and search space set indices.

Aspect 7: The method of any of aspects 2 through 6, wherein the plurality of PDCCH candidates that are distributed across the multiple sub-bands are part of a virtual carrier, wherein the virtual carrier is a primary cell when aggregated with other cells, and wherein the method further comprises: refraining from monitoring a third search space set based at least in part on a dropping rule, wherein the dropping rule indicates that search space sets are dropped from monitoring based on an ordering of candidate indices.

Aspect 8: The method of any of aspects 2 through 7, further comprising: transmitting a UE report indicating a quantity of blind decodes based at least in part on a quantity of associated search space sets indicated by the configuration information.

Aspect 9: The method of any of aspects 2 through 8, wherein an effective AL corresponding to the plurality of PDCCH candidates is based at least in part on a quantity of sub-bands associated with the plurality of PDCCH candidates.

Aspect 10: The method of aspect 9, wherein the effective AL is based on a uniform distribution of CCEs of a PDCCH candidate having a first AL within a search space set associated with the plurality of PDCCH candidates across the quantity of sub-bands.

Aspect 11: The method of any of aspects 9 through 10, wherein the effective AL is based on a non-uniform distribution of CCEs of a PDCCH candidate having a first AL within a search space set associated with the plurality of PDCCH candidates across the quantity of sub-bands.

Aspect 12: The method of any of aspects 1 through 11, wherein the first PDCCH CORESET and the second PDCCH CORESET are different, and the first search space set and the second search space set are portions of a same search space set.

Aspect 13: The method of aspect 12, wherein the first search space set comprises a quantity of control channel resources on the first PDCCH CORESET and the second search space set comprises the quantity of control channel resources on the second PDCCH CORESET, and a first PDCCH candidate associated with the first search space set and a second PDCCH candidate associated with the second search space set have a same AL, the first PDCCH candidate and the second PDCCH candidate being of the plurality of PDCCH candidates.

Aspect 14: The method of any of aspects 12 through 13, wherein the plurality of PDCCH candidates that are distributed across the multiple sub-bands are part of a virtual carrier, wherein the virtual carrier is a primary cell when aggregated with other cells, and wherein the method further comprises: refraining from monitoring the first search space set based at least in part on a dropping rule, wherein the dropping rule indicates that search space sets are dropped from monitoring based on an ordering of sub-band indices and search space set indices.

Aspect 15: The method of any of aspects 12 through 14, wherein the plurality of PDCCH candidates that are distributed across the multiple sub-bands are part of a virtual carrier, wherein the virtual carrier is a primary cell when aggregated with other cells, and wherein the method further comprises: refraining from monitoring the first search space set based at least in part on a dropping rule, wherein the dropping rule indicates that search space sets are dropped from monitoring based on an ordering of candidate indices.

Aspect 16: The method of any of aspects 12 through 15, wherein an effective AL corresponding to the plurality of PDCCH candidates is based at least in part on a quantity of control channel resources associated with the plurality of PDCCH candidates and a same AL.

Aspect 17: The method of aspect 16, wherein the effective AL is based on a uniform distribution of CCEs of a PDCCH candidate having a first AL within the same search space set associated with the plurality of PDCCH candidates across the quantity of sub-bands.

Aspect 18: The method of any of aspects 16 through 17, wherein the effective AL is based on a non-uniform distribution of CCEs of a PDCCH candidate having a first AL within the same search space set associated with the plurality of PDCCH candidates across the quantity of sub-bands.

Aspect 19: The method of any of aspects 12 through 18, further comprising: transmitting a UE report indicating a quantity of blind decodes based at least in part on a quantity of associated search space sets indicated by the configuration information.

Aspect 20: The method of any of aspects 1 through 19, wherein the first PDCCH CORESET and the second PDCCH CORESET are portions of a same PDCCH CORESET, and the same PDCCH CORESET includes a first RB set in the first sub-band and a second RB set in the second sub-band.

Aspect 21: The method of aspect 20, wherein the first RB set is associated with a first QCL source and a first TCI state, the second RB set is associated with a second QCL source and a second TCI state, the first QCL source is different than the second QCL source, and the first TCI state is different than the second TCI state.

Aspect 22: The method of any of aspects 20 through 21, wherein the first search space set and the second search space set are portions of a same search space set, and the first search space set is associated with the first RB set and the second search space set is associated with the second RB set.

Aspect 23: The method of aspect 22, wherein the same search space set is associated with a hashing function for the first RB set and the second RB set, and the first RB set and the second RB set comprise a same quantity of control channel resources.

Aspect 24: The method of any of aspects 22 through 23, wherein the same search space set is associated with a first hashing function for the first RB set and a second hashing function for the second RB set.

Aspect 25: The method of any of aspects 20 through 24, wherein the first search space set and the second search space set are different, and the first search space set is associated with the first RB set and the second search space set is associated with the second RB set.

Aspect 26: The method of aspect 25, wherein the first search space set is associated with a first hashing function for the first RB set and the second search space set is associated with a second hashing function for the second RB set.

Aspect 27: The method of any of aspects 20 through 26, wherein CCEs of a PDCCH candidate having a first AL associated within a search space set of the same PDCCH CORESET are uniformly distributed across a quantity of sub-bands associated with the same PDCCH CORESET.

Aspect 28: The method of aspect 27, wherein each REG bundle of the same PDCCH CORESET is comprised within a respective sub-band.

Aspect 29: The method of any of aspects 20 through 28, wherein CCEs of a PDCCH candidate having a respective AL within a search space set of the same PDCCH CORESET are non-uniformly distributed across a quantity of sub-bands associated with the same PDCCH CORESET.

Aspect 30: The method of aspect 29, wherein a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

Aspect 31: The method of claim 20, wherein an effective AL corresponding to the plurality of PDCCH candidates is based at least in part on a quantity of RBs associated with the plurality of PDCCH candidates.

Aspect 32: A method for wireless communications at a network entity, comprising: transmitting configuration information that indicates a plurality of monitoring occasions in multiple sub-bands for monitoring of a plurality of PDCCH candidates for reception of a control channel or repetitions of the control channel, wherein plurality of PDCCH candidates are distributed across the multiple sub-bands; transmitting, in accordance with the configuration information, a first control message during a first monitoring occasion of the plurality of monitoring occasions, wherein the first monitoring occasion is associated with a first search space of a first PDCCH CORESET in a first sub-band of the multiple sub-bands; and transmitting, in accordance with the configuration information, a second control message during a second monitoring occasion of the plurality of monitoring occasions, wherein the second monitoring occasion is associated with a second search space of a second PDCCH CORESET in a second sub-band of the multiple sub-bands, wherein the configuration information associates the first search space with the second search space.

Aspect 33: The method of aspect 32, wherein the first PDCCH CORESET and the second PDCCH CORESET are different, and the first search space set and the second search space set are different.

Aspect 34: The method of aspect 33, wherein the first search space set and the second search space set are associated via a mapping between search space sets of different sub-bands, and the mapping is on a per group of PDCCH candidates basis.

Aspect 35: The method of any of aspects 33 through 34, wherein a first coreset configuration associated with the first PDCCH CORESET is independent of a second PDCCH CORESET configuration associated with the second PDCCH CORESET.

Aspect 36: The method of any of aspects 33 through 35, wherein one or more parameters of a first coreset configuration associated with the first PDCCH CORESET are the same as a corresponding one or more parameters of a second PDCCH CORESET configuration associated with the second PDCCH CORESET, the one or more parameters include at least one of an AL, a payload, a quantity of coded bits, or a search space set type.

Aspect 37: The method of any of aspects 33 through 36, further comprising: receiving a UE report indicating a quantity of blind decodes based at least in part on a quantity of associated search space sets indicated by the configuration information.

Aspect 38: The method of any of aspects 33 through 37, wherein an effective AL corresponding to the plurality of PDCCH candidates is based at least in part on a quantity of sub-bands associated with the plurality of PDCCH candidates.

Aspect 39: The method of aspect 38, wherein the effective AL is based on a uniform distribution of CCEs of a PDCCH candidate having a first AL within a search space set associated with the plurality of PDCCH candidates across the quantity of sub-bands.

Aspect 40: The method of any of aspects 38 through 39, wherein the effective AL is based on a non-uniform distribution of CCEs of a PDCCH candidate having a first AL within a search space set associated with the plurality of PDCCH candidates across the quantity of sub-bands.

Aspect 41: The method of any of aspects 32 through 40, wherein the first PDCCH CORESET and the second PDCCH CORESET are different, and the first search space set and the second search space set are portions of a same search space set.

Aspect 42: The method of aspect 41, wherein the first search space set comprises a quantity of control channel resources on the first PDCCH CORESET and the second search space set comprises the quantity of control channel resources on the second PDCCH CORESET, and a first PDCCH candidate associated with the first search space set and a second PDCCH candidate associated with the second search space set have a same AL, the first PDCCH candidate and the second PDCCH candidate being of the plurality of PDCCH candidates.

Aspect 43: The method of any of aspects 41 through 42, wherein an effective AL corresponding to the plurality of PDCCH candidates is based at least in part on a quantity of control channel resources associated with the plurality of PDCCH candidates and a same AL.

Aspect 44: The method of aspect 43, wherein the effective AL is based on a uniform distribution of CCEs of a PDCCH candidate having a first AL within the same search space set associated with the plurality of PDCCH candidates across the quantity of sub-bands.

Aspect 45: The method of any of aspects 43 through 44, wherein the effective AL is based on a non-uniform distribution of CCEs of a PDCCH candidate having a first AL within the same search space set associated with the plurality of PDCCH candidates across the quantity of sub-bands.

Aspect 46: The method of any of aspects 41 through 45, further comprising: receiving a UE report indicating a quantity of blind decodes based at least in part on a quantity of associated search space sets indicated by the configuration information.

Aspect 47: The method of any of aspects 32 through 46, wherein the first PDCCH CORESET and the second PDCCH CORESET are portions of a same PDCCH CORESET, and the same PDCCH CORESET includes a first RB set in the first sub-band and a second RB set in the second sub-band.

Aspect 48: The method of aspect 47, wherein the first RB set is associated with a first QCL source and a first TCI state, the second RB set is associated with a second QCL source and a second TCI state, the first QCL source is different than the second QCL source, and the first TCI state is different than the second TCI state.

Aspect 49: The method of any of aspects 47 through 48, wherein the first search space set and the second search space set are portions of a same search space set, and the first search space set is associated with the first RB set and the second search space set is associated with the second RB set.

Aspect 50: The method of aspect 49, wherein the same search space set is associated with a hashing function for the first RB set and the second RB set, and the first RB set and the second RB set comprise a same quantity of control channel resources.

Aspect 51: The method of any of aspects 49 through 50, wherein the same search space set is associated with a first hashing function for the first RB set and a second hashing function for the second RB set.

Aspect 52: The method of any of aspects 47 through 51, wherein the first search space set and the second search space set are different, and the first search space set is associated with the first RB set and the second search space set is associated with the second RB set.

Aspect 53: The method of aspect 52, wherein the first search space set is associated with a first hashing function for the first RB set and the second search space set is associated with a second hashing function for the second RB set.

Aspect 54: The method of any of aspects 47 through 53, wherein CCEs of a PDCCH candidate having a first AL associated within a search space set of the same PDCCH CORESET are uniformly distributed across a quantity of sub-bands associated with the same PDCCH CORESET.

Aspect 55: The method of aspect 54, wherein each REG bundle of the same PDCCH CORESET is comprised within a respective sub-band.

Aspect 56: The method of any of aspects 47 through 55, wherein CCEs of a PDCCH candidate having a respective AL within a search space set of the same PDCCH CORESET are non-uniformly distributed across a quantity of sub-bands associated with the same PDCCH CORESET.

Aspect 57: The method of aspect 56, wherein a first PDCCH candidate of the first RB set and a second PDCCH candidate of the second RB set may be linked, an effective AL corresponding to a third PDCCH candidate associated with the first RB set and the second RB set may be a sum of a first AL associated with the first PDCCH candidate and a second AL associated with the second PDCCH candidate.

Aspect 58: The method of claim 47, wherein an effective AL corresponding to the plurality of PDCCH candidates is based at least in part on a quantity of RBs associated with the plurality of PDCCH candidates.

Aspect 59: A UE for wireless communications, comprising one or more memories storing processor-executable code, and one or more processors coupled with the one or more memories and individually or collectively operable to execute the code to cause the UE to perform a method of any of aspects 1 through 31.

Aspect 60: A UE for wireless communications, comprising at least one means for performing a method of any of aspects 1 through 31.

Aspect 61: A non-transitory computer-readable medium storing code for wireless communications, the code comprising instructions executable by one or more processors to perform a method of any of aspects 1 through 31.

Aspect 62: A network entity for wireless communications, comprising one or more memories storing processor-executable code, and one or more processors coupled with the one or more memories and individually or collectively operable to execute the code to cause the network entity to perform a method of any of aspects 32 through 58.

Aspect 63: A network entity for wireless communications, comprising at least one means for performing a method of any of aspects 32 through 58.

Aspect 64: A non-transitory computer-readable medium storing code for wireless communications, the code comprising instructions executable by one or more processors to perform a method of any of aspects 32 through 58.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates a plurality of monitoring occasions in multiple sub-bands for monitoring of a plurality of physical downlink control channel (PDCCH) candidates for reception of a control channel or repetitions of the control channel, wherein the plurality of PDCCH candidates are distributed across the multiple sub-bands;
perform, in accordance with the configuration information, a first set of blind decodes during a first monitoring occasion of the plurality of monitoring occasions, wherein the first monitoring occasion is associated with a first search space set of a first PDCCH core resource set (CORESET) in a first sub-band of the multiple sub-bands;
perform, in accordance with the configuration information, a second set of blind decodes during a second monitoring occasion of the plurality of monitoring occasions, wherein the second monitoring occasion is associated with a second search space set of a second PDCCH CORESET in a second sub-band of the multiple sub-bands, wherein the configuration information associates the first search space set with the second search space set; and
decode the control channel or the repetitions of the control channel based at least in part on the first set of blind decodes and the second set of blind decodes.

2. The UE of claim 1, wherein the first PDCCH CORESET and the second PDCCH CORESET are different, and the first search space set and the second search space set are different.

3. The UE of claim 2, wherein:
the first search space set and the second search space set are associated via a mapping between search space sets of different sub-bands, and
the mapping is on a per group of PDCCH candidates basis.

4. The UE of claim 2, wherein the plurality of PDCCH candidates that are distributed across the multiple sub-bands are part of a virtual carrier, and the one or more processors are individually or collectively further operable to execute the code to cause the UE to:
refrain from monitoring a third search space set based at least in part on a dropping rule, wherein the dropping rule indicates that search space sets are dropped from monitoring based at least in part on an ordering of sub-band indices and search space set indices.

5. The UE of claim 2, wherein the plurality of PDCCH candidates that are distributed across the multiple sub-bands are part of a virtual carrier, and the one or more processors are individually or collectively further operable to execute the code to cause the UE to:
refrain from monitoring a third search space set based at least in part on a dropping rule, wherein the dropping rule indicates that search space sets are dropped from monitoring based at least in part on an ordering of candidate indices.

6. The UE of claim 2, wherein the one or more processors are individually or collectively further operable to execute the code to cause the UE to:
transmit a UE report indicating a quantity of blind decodes based at least in part on a quantity of associated search space sets indicated by the configuration information.

7. The UE of claim 2, wherein an effective aggregation level corresponding to the plurality of PDCCH candidates is based at least in part on a quantity of sub-bands associated with the plurality of PDCCH candidates.

8. The UE of claim 7, wherein the effective aggregation level is based at least in part on a uniform distribution of control channel elements of a PDCCH candidate having a first aggregation level within a search space set associated with the plurality of PDCCH candidates across the quantity of sub-bands.

9. The UE of claim 7, wherein the effective aggregation level is based at least in part on a non-uniform distribution of control channel elements of a PDCCH candidate having a first aggregation level within a search space set associated with the plurality of PDCCH candidates across the quantity of sub-bands.

10. The UE of claim 1, wherein the first PDCCH CORESET and the second PDCCH CORESET are different, and the first search space set and the second search space set are portions of a same search space set.

11. The UE of claim 10, wherein the plurality of PDCCH candidates that are distributed across the multiple sub-bands are part of a virtual carrier, and the one or more processors are individually or collectively further operable to execute the code to cause the UE to:
refrain from monitoring the first search space set based at least in part on a dropping rule, wherein the dropping rule indicates that search space sets are dropped from monitoring based at least in part on an ordering of sub-band indices and search space set indices.

12. The UE of claim 10, wherein the plurality of PDCCH candidates that are distributed across the multiple sub-bands are part of a virtual carrier, and the one or more processors are individually or collectively further operable to execute the code to cause the UE to:
refrain from monitoring the first search space set based at least in part on a dropping rule, wherein the dropping rule indicates that search space sets are dropped from monitoring based at least in part on an ordering of candidate indices.

13. The UE of claim 10, wherein an effective aggregation level corresponding to the plurality of PDCCH candidates is based at least in part on a quantity of control channel resources associated with the plurality of PDCCH candidates and a same aggregation level.

14. The UE of claim 13, wherein the effective aggregation level is based at least in part on a uniform distribution of control channel elements of a PDCCH candidate having a first aggregation level within the same search space set associated with the plurality of PDCCH candidates across the quantity of sub-bands.

15. The UE of claim 13, wherein the effective aggregation level is based at least in part on a non-uniform distribution of control channel elements of a PDCCH candidate having a first aggregation level within the same search space set associated with the plurality of PDCCH candidates across the quantity of sub-bands.

16. The UE of claim 1, wherein:
the first PDCCH CORESET and the second PDCCH CORESET are portions of a same PDCCH CORESET, and
the same PDCCH CORESET includes a first resource block (RB) set in the first sub-band and a second RB set in the second sub-band.

17. The UE of claim 16, wherein:
the first search space set and the second search space set are portions of a same search space set, and
the first search space set is associated with the first RB set and the second search space set is associated with the second RB set.

18. The UE of claim 17, wherein:
the same search space set is associated with a hashing function for the first RB set and the second RB set, and
the first RB set and the second RB set comprise a same quantity of control channel resources.

19. The UE of claim 17, wherein the same search space set is associated with a first hashing function for the first RB set and a second hashing function for the second RB set.

20. The UE of claim 16, wherein:
the first search space set and the second search space set are different, and
the first search space set is associated with the first RB set and the second search space set is associated with the second RB set.

21. The UE of claim 20, wherein the first search space set is associated with a first hashing function for the first RB set and the second search space set is associated with a second hashing function for the second RB set.

22. The UE of claim 16, wherein control channel elements of a PDCCH candidate having a first aggregation level associated within a search space set of the same PDCCH CORESET are uniformly distributed across a quantity of sub-bands associated with the same PDCCH CORESET.

23. The UE of claim 16, wherein control channel elements of a PDCCH candidate having a respective aggregation level within a search space set of the same PDCCH CORESET are non-uniformly distributed across a quantity of sub-bands associated with the same PDCCH CORESET.

24. The UE of claim 16, wherein an effective aggregation level corresponding to the plurality of PDCCH candidates is based at least in part on a quantity of RBs associated with the plurality of PDCCH candidates.

25. A network entity, comprising:
one or more memories storing processor-executable code; and
one or more processors coupled with the one or more memories and individually or collectively operable to execute the code to cause the network entity to:
transmit configuration information that indicates a plurality of monitoring occasions in multiple sub-bands for monitoring of a plurality of physical downlink control channel (PDCCH) candidates for reception of a control channel or repetitions of the control channel, wherein plurality of PDCCH candidates are distributed across the multiple sub-bands;
transmit, in accordance with the configuration information, a first control message during a first monitoring occasion of the plurality of monitoring occasions, wherein the first monitoring occasion is associated with a first search space of a first PDCCH core resource set (CORESET) in a first sub-band of the multiple sub-bands; and
transmit, in accordance with the configuration information, a second control message during a second monitoring occasion of the plurality of monitoring occasions, wherein the second monitoring occasion is associated with a second search space of a second PDCCH CORESET in a second sub-band of the multiple sub-bands, wherein the configuration information associates the first search space with the second search space.

26. The network entity of claim 25, wherein the first PDCCH CORESET and the second PDCCH CORESET are different, and the first search space set and the second search space set are different.

27. The network entity of claim 25, wherein the first PDCCH CORESET and the second PDCCH CORESET are different, and the first search space set and the second search space set are portions of a same search space set.

28. The network entity of claim 25, wherein:
the first PDCCH CORESET and the second PDCCH CORESET are portions of a same PDCCH CORESET, and
the same PDCCH CORESET includes a first resource block (RB) set in the first sub-band and a second RB set in the second sub-band.

29. A method for wireless communications at a user equipment (UE), comprising:
receiving configuration information that indicates a plurality of monitoring occasions in multiple sub-bands for monitoring of a plurality of physical downlink control channel (PDCCH) candidates for reception of a control channel or repetitions of the control channel, wherein the plurality of PDCCH candidates are distributed across the multiple sub-bands;
performing, in accordance with the configuration information, a first set of blind decodes during a first monitoring occasion of the plurality of monitoring occasions, wherein the first monitoring occasion is associated with a first search space set of a first PDCCH core resource set (CORESET) in a first sub-band of the multiple sub-bands;
performing, in accordance with the configuration information, a second set of blind decodes during a second monitoring occasion of the plurality of monitoring occasions, wherein the second monitoring occasion is associated with a second search space set of a second PDCCH CORESET in a second sub-band of the multiple sub-bands, wherein the configuration information associates the first search space set with the second search space set; and
decoding the control channel or the repetitions of the control channel based at least in part on the first set of blind decodes and the second set of blind decodes.

30. A method for wireless communications at a network entity, comprising:
transmitting configuration information that indicates a plurality of monitoring occasions in multiple sub-bands for monitoring of a plurality of physical downlink control channel (PDCCH) candidates for reception of a control channel or repetitions of the control channel, wherein plurality of PDCCH candidates are distributed across the multiple sub-bands;
transmitting, in accordance with the configuration information, a first control message during a first monitoring occasion of the plurality of monitoring occasions, wherein the first monitoring occasion is associated with a first search space of a first PDCCH core resource set (CORESET) in a first sub-band of the multiple sub-bands; and
transmitting, in accordance with the configuration information, a second control message during a second monitoring occasion of the plurality of monitoring occasions, wherein the second monitoring occasion is associated with a second search space of a second PDCCH CORESET in a second sub-band of the multiple sub-bands, wherein the configuration information associates the first search space with the second search space.
